(19) United States
(12) Patent Application Publication
(10) Pub. No.: US 2026/0290327 A1
(43) Pub. Date: Sep. 24, 2026

(54) SYSTEM

(71) Applicant: SoftBank Group Corp., Tokyo (JP)

(72) Inventor: Mari ANDO, Tokyo (JP)

(73) Assignee: SoftBank Group Corp., Tokyo (JP)

(21) Appl. No.: 19/567,371

(22) Filed: Mar. 16, 2026

(30) Foreign Application Priority Data
Mar. 19, 2025 (JP) 2025-045053

(51) Int. Cl. G10L 15/16; G06N 3/0475; G10L 25/51

(52) U.S. Cl. CPC G10L 15/16; G06N 3/0475; G10L 25/51

(57) ABSTRACT

A system includes a processor that is configured to receive language data of a user, provide, to a generative artificial intelligence model, a first prompt that instructs the generative artificial intelligence model to analyze a language ability of the user based on the language data, and execute analysis of the language data by using the generative artificial intelligence model, evaluate an output obtained from the generative artificial intelligence model based on the analysis in order to identify one or more weaknesses of the user, provide, to the generative artificial intelligence model, a second prompt that instructs the generative artificial intelligence model to generate feedback corresponding to the identified one or more weaknesses, and obtain feedback generated by the generative artificial intelligence model in response to the second prompt, and cause the generated feedback to be provided to the user by displaying the generated feedback through a user interface.

### CROSS-REFERENCE TO RELATED APPLICATION

This application is based on and claims priority under 35 USC 119 from Japanese Patent Application No. 2025-045053 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional computer-assisted language learning systems generally rely on predetermined rules, fixed question banks, and static feedback templates. Such systems often fail to (i) capture the nuanced and individual patterns of user errors, (ii) flexibly adapt the content and feedback to the user's changing proficiency level, and (iii) provide rich, context-sensitive guidance for improvement. In many cases, existing systems simply mark answers as correct or incorrect without explaining why an expression is unnatural, how a grammatical rule is being misused, or which specific aspects of pronunciation require attention. Moreover, even when analysis is performed, it is typically separated from feedback generation, resulting in fragmented user experiences where the analysis output is not fully leveraged to create tailored feedback. As a result, users do not receive sufficiently personalized, dynamic, or detailed feedback to effectively strengthen their weaknesses in grammar, pronunciation, and other aspects of language ability.

Therefore, there is a need for a system that can automatically receive user language data, analyze the user's language ability by using a generative artificial intelligence model, identify individual weaknesses based on that analysis, and generate and present adaptive feedback that is tailored to the user's error patterns and learning progress. There is a further need for a system that can exploit prompts for the generative artificial intelligence model to direct not only the analysis of user language data, including grammatical and pronunciation issues, but also the dynamic adjustment of feedback content in accordance with the user's past learning history and current learning stage.

### SUMMARY

In order to solve the above-described problems, the present invention provides a system comprising a processor, wherein the processor is configured to receive language data of a user and to cooperate with a generative artificial intelligence model via prompts so as to perform integrated analysis and feedback generation.

Specifically, the processor is configured to receive, from a user interface, language data of the user, such as text input or speech input, and to provide a first prompt to a generative artificial intelligence model. The first prompt instructs the generative artificial intelligence model to analyze a language ability of the user based on the received language data. The processor then executes analysis of the language data by using the generative artificial intelligence model, and evaluates an output obtained from the generative artificial intelligence model in order to identify one or more weaknesses of the user, such as grammatical errors, inappropriate word usage, or pronunciation problems.

Furthermore, the processor is configured to provide a second prompt to the generative artificial intelligence model, the second prompt instructing the generative artificial intelligence model to generate feedback corresponding to the identified one or more weaknesses. In response to the second prompt, the processor obtains feedback generated by the generative artificial intelligence model, and causes the generated feedback to be provided to the user by displaying the feedback through the user interface.

In one aspect of the invention, the processor is configured to use a prompt that instructs the generative artificial intelligence model, when analyzing the language data of the user, to explicitly point out grammatical errors and pronunciation problems and to propose methods for improvement based on an analysis result. In another aspect of the invention, the processor is configured to use a prompt that instructs the generative artificial intelligence model to adjust the feedback to be provided according to a learning progress of the user, and to dynamically modify the generated feedback in consideration of past learning data of the user. Through these configurations, the system can provide personalized, context-aware, and adaptively updated feedback that effectively targets and improves the user's weaknesses in language ability.

The term “system” refers to a combination of hardware and software components including at least one processor and associated memory, communication interfaces, and a user interface, which cooperatively perform the functions described in the claims.

The term “processor” refers to one or more hardware processing units, such as a central processing unit (CPU), graphics processing unit (GPU), or dedicated accelerator, and may include a plurality of such units operating in concert, configured to execute instructions that implement the functions described in the claims.

The term “language data” refers to data representing linguistic expressions produced by a user, including but not limited to text data (such as sentences, phrases, or documents) and speech data (such as recorded audio of spoken utterances), in one or more natural languages.

The term “user” refers to an individual who interacts with the system, provides language data for analysis, and receives feedback generated by the system for the purpose of practicing or improving language ability.

The term “generative artificial intelligence model” refers to a machine learning model, such as a large language model or a multimodal generative model, that is trained on large-scale data and is capable of generating text or other outputs in response to input prompts.

The term “prompt” refers to data, typically including text instructions and optionally contextual information or examples, that is provided as input to the generative artificial intelligence model in order to specify or constrain the type, content, or style of the output to be generated by the generative artificial intelligence model.

The term “analyze a language ability of the user” refers to processing the user's language data by using the generative artificial intelligence model to estimate or determine characteristics of the user's linguistic competence, such as grammatical accuracy, vocabulary usage, fluency, pronunciation, and comprehension.

The term “output obtained from the generative artificial intelligence model” refers to data, typically including generated text or structured information, that is produced by the generative artificial intelligence model in response to a prompt provided by the processor.

The term “weakness” refers to an aspect of the user's language ability in which the user exhibits lower proficiency or more frequent errors relative to other aspects, such as recurrent grammatical mistakes, limited vocabulary range, or specific pronunciation problems.

The term “identify one or more weaknesses of the user” refers to determining, based on analysis results and the model output, which specific linguistic aspects, skills, or patterns constitute weaknesses for the user.

The term “feedback” refers to information generated for presentation to the user that explains, comments on, or guides correction of the user's language data, including for example error explanations, corrected examples, improvement strategies, and practice suggestions.

The term “generate feedback corresponding to the identified one or more weaknesses” refers to creating feedback content by using the generative artificial intelligence model so that the feedback is specifically targeted to the weaknesses identified for the user.

The term “user interface” refers to hardware and software components, such as a graphical user interface on a display, a web interface, or a mobile application interface, through which the user can input language data and receive or view the generated feedback.

The term “displaying the generated feedback” refers to presenting the feedback to the user via the user interface, including showing text on a screen, rendering graphical elements, and optionally playing associated audio or multimedia elements.

The term “learning progress of the user” refers to information representing changes over time in the user's language ability, including completed exercises, past scores, history of errors, and previously generated feedback.

The term “past learning data of the user” refers to stored data related to the user's previous interactions with the system, including prior language data submissions, analysis results, scores, completion status of materials, and earlier feedback that has been generated and provided.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

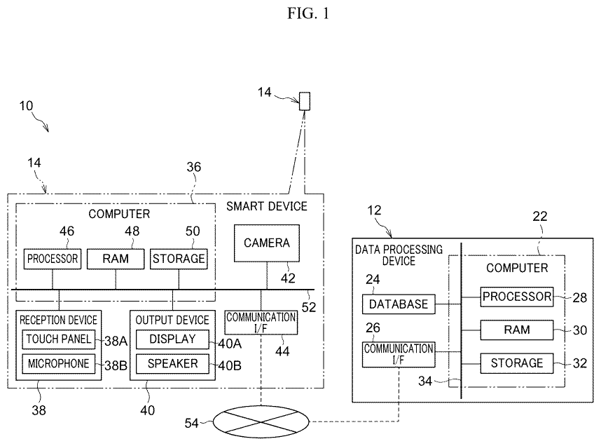

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

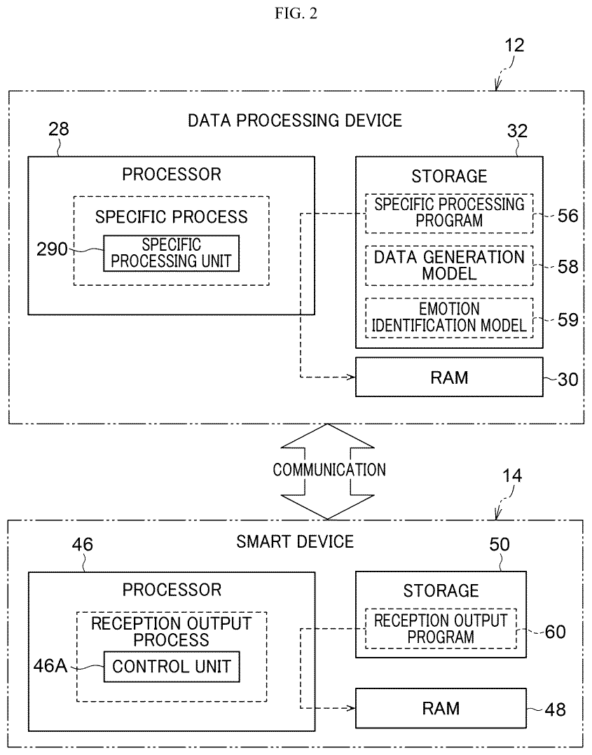

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented language learning systems typically rely on rule-based grammar checkers, fixed error catalogs, or static exercise databases. These systems often perform shallow pattern matching on text and may use separate, loosely coupled modules for grammar checking and pronunciation scoring. As a result, such systems face several technical limitations.

First, conventional systems are not architected to orchestrate a generative artificial intelligence model through dynamically constructed prompt sentences in accordance with a user's evolving error patterns. A typical system simply feeds raw user text to a language model or to a grammar-checking engine, receives unstructured output, and then presents the output directly. This architecture does not maintain a machine-usable, persistent weakness profile for each user at the level of structured error categories, and it does not use such a profile to programmatically control subsequent analysis, feedback generation, and interactive practice. Consequently, the processing unit cannot adapt its own later computations based on prior inference results in a fine-grained and automated manner.

Second, conventional systems do not tightly integrate audio processing, speech recognition, and pronunciation evaluation into a unified analysis pipeline that feeds structured results into a generative artificial intelligence model. Audio inputs, where supported, are often handled in a separate subsystem that only returns a numeric pronunciation score or a coarse assessment. The grammatical and lexical analysis of recognized text is not consistently correlated with phoneme-level or word-level pronunciation errors. This fragmented architecture prevents the processor from building and updating a unified weakness profile that spans grammar, vocabulary, pronunciation, and accent, thereby limiting the system's capability to generate coordinated feedback and exercises based on a holistic view of the user's performance.

Third, existing systems generally do not use the output of a generative artificial intelligence model as machine-readable structural data that drives further computation. When a generative model is used, its free-text output is typically displayed directly to the user rather than parsed and aggregated by the processor. Without a design that instructs the generative model, via specific prompt sentences, to output errors, corrections, and explanations in a structured format, the system cannot accurately compute error frequencies by category, cannot maintain a robust weakness profile, and cannot algorithmically modify future prompt sentences or feedback granularity. This results in a static and inefficient use of computational resources, where each analysis is essentially independent and does not improve the internal state of the system.

Fourth, conventional systems lack a feedback loop in which user-initiated prompt sentences for additional grammar checking or practice generation are programmatically combined with stored weakness profiles and used to construct new, context-aware prompt sentences to the generative artificial intelligence model. In many cases, the user interacts directly with a model or a simple grammar checker without any intermediate computation that takes into account the user's historical weaknesses. This limits the system's ability to allocate processing effort where it is most needed and to generate targeted practice content that reflects accumulating knowledge about the user's behavior.

Accordingly, there is a need for an improved computer-implemented system that integrates input acquisition, speech recognition, generative artificial intelligence-based analysis, pronunciation evaluation, structured error categorization, persistent weakness profiling, and dynamic prompt generation into a unified processing pipeline executed by a processor. By doing so, the system can more effectively utilize computational resources, maintain and update detailed user-specific state, and control the behavior of the generative artificial intelligence model in a way that enhances accuracy, adaptability, and efficiency of language analysis and feedback generation. The technical problem to be solved is to improve the functioning of the computer system itself, by enabling the processor to automatically orchestrate multiple components including a generative artificial intelligence model through machine-constructed prompt sentences and structured data flows, so as to generate adaptive, fine-grained feedback and practice content based on accumulated user-specific error information.

The specific processing by the specific processing unit 290 of the data processing device 12 in Example 1 is realized by the following means.

The present invention provides a server comprising a processor and a storage device, the processor being configured to execute instructions that cause the server to receive, via a user interface of a terminal, language data from a user, the language data including text data and audio data; to convert, when the language data includes the audio data, the audio data into character string data by using a speech recognition function; to obtain analysis target data as the text data or as the character string data converted from the audio data; to input, to a generative artificial intelligence model, a first prompt sentence that instructs the generative artificial intelligence model to perform analysis processing for identifying grammatical errors and inappropriate lexical usage in the analysis target data and to output analysis results in a structured data format including error positions, correction examples, and explanations; to execute, for the audio data, an audio evaluation function that evaluates pronunciation and accent at least on a word unit basis or a phoneme unit basis and outputs evaluation results including error categories and scores; to classify, on the basis of the analysis results and the evaluation results, errors relating to grammar, vocabulary, and pronunciation into categories and to store and update the categories, together with occurrence frequencies, as a weakness profile for the user in the storage device; to generate, on the basis of the weakness profile and the analysis target data, a second prompt sentence that instructs the generative artificial intelligence model to generate feedback including descriptions of user weaknesses, correction examples, learning example sentences, and practice items corresponding to error categories; to input the second prompt sentence to the generative artificial intelligence model and to acquire feedback data output from the generative artificial intelligence model; to cause the feedback data to be displayed via the user interface and presented to the user; to obtain, from the user via the user interface, an input including a user-originated prompt sentence requesting additional grammar checking or generation of practice problems; and to generate, on the basis of the user-originated prompt sentence and the weakness profile, a third prompt sentence that instructs the generative artificial intelligence model to generate additional feedback or practice problems tailored to the user's accumulated weaknesses, to input the third prompt sentence to the generative artificial intelligence model, and to provide, via the user interface, output from the generative artificial intelligence model as the additional feedback or the practice problems to the user. This enables the server to maintain and update a structured, user-specific weakness profile and to dynamically control, via machine-constructed prompt sentences, the operation of the generative artificial intelligence model and associated audio processing so that the computer system itself performs more adaptive, efficient, and fine-grained analysis and feedback generation for language learning.

The term “system” refers to a combination of one or more computing devices, including at least one processor and one or more storage resources, configured to execute the claimed functions in cooperation with each other.

The term “processor” refers to a hardware processing unit, such as a central processing unit or a processing core, that executes instructions to perform arithmetic, logic, control, and input/output operations required by the system.

The term “storage device” refers to a hardware storage resource, such as a memory device or a persistent storage medium, configured to store programs, data, profiles, and intermediate results used by the processor.

The term “terminal” refers to an information processing device, such as a client computing device or a user equipment, that provides a user interface for inputting and outputting information to and from the system.

The term “user interface” refers to a hardware and software arrangement, such as a graphical user interface or an audio interface, through which the user can input data to the system and receive output from the system.

The term “user” refers to a person or entity that interacts with the system via the terminal to provide language data and to receive feedback or practice content.

The term “language data” refers to information representing natural language expressions, including at least text data and audio data containing spoken utterances.

The term “text data” refers to language data represented as a sequence of characters or symbols in a written form.

The term “audio data” refers to language data represented as digital audio signals corresponding to spoken language.

The term “character string data” refers to text data obtained from language data, including text originally input as text and text generated by converting audio data through speech recognition.

The term “analysis target data” refers to character string data that is supplied to analysis processes, including data originally input as text data and data obtained by converting audio data into text.

The term “speech recognition function” refers to a processing function, executable by hardware and software, that receives audio data and outputs corresponding character string data representing recognized speech.

The term “audio evaluation function” refers to a processing function, executable by hardware and software, that receives audio data and associated text and outputs evaluation results regarding pronunciation, accent, or other speech-related features.

The term “generative artificial intelligence model” refers to a trained machine learning model configured to generate natural language output in response to input data and instructions, including models that perform natural language understanding and generation based on training data.

The term “prompt sentence” refers to an instruction sequence or text input provided to the generative artificial intelligence model, defining analysis tasks, output formats, or content to be generated by the generative artificial intelligence model.

The term “analysis processing” refers to computational operations performed by the generative artificial intelligence model and associated components to detect, classify, and describe characteristics or errors in analysis target data.

The term “grammatical error” refers to a deviation in syntax or morphological form of language data from a predefined grammatical rule set used for evaluation.

The term “inappropriate lexical usage” refers to an unnatural, incorrect, or contextually unsuitable use of words or phrases in language data as determined by a linguistic criterion.

The term “analysis result” refers to information generated by the generative artificial intelligence model or by other analysis components that describes identified errors, corrections, explanations, or related metadata for the analysis target data.

The term “evaluation result” refers to information generated by the audio evaluation function that describes pronunciation quality, accent characteristics, detected mispronunciations, and associated scores or categories.

The term “error category” refers to a classification label that groups similar types of errors, including categories such as grammar-related errors, vocabulary-related errors, and pronunciation-related errors.

The term “weakness profile” refers to structured data stored for each user that aggregates error categories, occurrence frequencies, and related analysis information representing persistent or characteristic weaknesses of the user.

The term “feedback” refers to information generated by the system and presented to the user, including descriptions of weaknesses, correction examples, explanations, practice items, or other instructional content.

The term “feedback data” refers to data output by the generative artificial intelligence model or by the processor that encodes feedback content to be presented to the user.

The term “practice problem” refers to an exercise item, such as a question or task, generated by the system to allow the user to practice specific language skills related to identified weaknesses.

The term “occurrence frequency” refers to a numerical value or count indicating how often a particular error category or error instance appears in analysis results associated with a user.

The term “structured data format” refers to a representation of data in a machine-readable and parsable form, such as a key-value structure, list structure, or schema-based representation, enabling programmatic extraction and further computation.

The term “user-originated prompt sentence” refers to a prompt sentence directly input by the user via the user interface to request additional analysis, feedback, or practice content.

The term “additional feedback” refers to feedback generated in response to a user-originated prompt sentence, in combination with the weakness profile, and supplementing previously provided feedback.

The term “dynamic control” refers to an operation in which the processor modifies the contents of prompt sentences, the level of detail of feedback, or the types of practice problems in response to accumulated analysis results or changes in the weakness profile.

In one embodiment, a server cooperates with one or more terminals operated by users to implement the claimed system. The server includes at least one processor, a main memory, a non-volatile storage device, and a network interface. The terminal includes an input device such as a keyboard, a touch screen, and a microphone, an output device such as a display and a speaker, and a communication module for exchanging data with the server over a network.

The server executes an operating system, for example a general-purpose server operating system, and an application stack including a web server such as an HTTP server, and an application framework such as a server-side scripting or web framework. The server further executes a speech recognition component, which may be implemented by a local speech-to-text engine or by invoking a remote speech recognition service through an application programming interface. The server also executes an audio evaluation component to assess pronunciation and accent, and a generative AI model client module that communicates with a remote or local generative AI model.

The generative AI model is implemented as a parameterized neural network trained for natural language understanding and generation. In one embodiment, the generative AI model is a transformer-based neural network including an input embedding layer, multiple self-attention layers, feed-forward layers, and an output projection layer. The model is trained on large-scale text corpora and optionally fine-tuned on corpora of learner English with annotated errors. During training, the model uses a loss function such as cross-entropy loss on predicted tokens and applies backpropagation with gradient-based optimization such as Adam. The model stores learned parameters as weight matrices and bias vectors in the storage device or in a dedicated model server. The server accesses the model through a model-serving API, using prompt sentences to specify the analysis task, output structure, and generation constraints.

The audio evaluation component is implemented as a neural network-based acoustic model combined with a pronunciation scoring algorithm. In one embodiment, the audio evaluation component includes an acoustic front end that extracts features such as Mel-frequency cepstral coefficients or log-mel spectrograms from the user's audio. The component then uses a sequence model, such as a recurrent neural network, a convolutional neural network, or a transformer-based speech model, to align the audio with target phoneme sequences corresponding to the recognized text. The component computes per-phoneme scores using a likelihood-based or distance-based measure and aggregates them into word-level and utterance-level pronunciation scores. The component outputs structured evaluation results that include, for each word or phoneme, a score, an error label, and timing information.

The server maintains structured data in one or more databases. The server stores raw user language data (text and audio), recognized character string data, analysis target data, analysis results from the generative AI model, evaluation results from the audio evaluation component, and weakness profiles. The server represents weakness profiles as structured records, for example as database tables or document structures, that list error categories such as subject-verb agreement, article misuse, tense errors, lexical choice errors, vowel mispronunciations, consonant cluster reductions, and misplaced stress, along with occurrence frequencies, timestamps, and severity scores.

The server uses specific data structures to manage the interaction with the generative AI model. For each analysis, the server constructs a prompt sentence that includes (i) a task description, (ii) formatting instructions for structured output, and (iii) the analysis target data. For example, the server may generate a prompt sentence such as:
“You are an English language tutor. Analyze the following learner sentence, identify all grammatical errors and inappropriate word usage, provide corrected versions, and briefly explain each correction. Return the result in a structured and unambiguous format that lists each error, the original fragment, the corrected fragment, and a short explanation. Sentence: ‘I has a book.’”

In another example, the server may generate a prompt sentence for more general analysis:
“You are an English tutor. For the following text, detect all grammar errors and unnatural vocabulary, and classify each error into one of the categories: subject-verb agreement, tense, article, preposition, word choice, or other. For each error, output the category, the original text, the corrected text, and a simple explanation. Text: ‘She go to school every day.’”

The server configures the generative AI model to output its analysis in a structured format that can be parsed deterministically, such as a list-like or key-value-like format with clear delimiters. The server then parses the output, extracts each error item, derives an error category, and updates the user's weakness profile accordingly. Because the output is structured, the server can compute error frequencies and trends across multiple sessions with high reliability and low parsing overhead, which improves computational efficiency and accuracy relative to systems that rely on free-form text output.

The server also constructs prompt sentences for generating feedback and practice material. In one embodiment, the server generates a feedback-oriented prompt sentence such as: “You are an English tutor. Based on the following analysis of the learner's errors, generate feedback suitable for an intermediate English learner. Include: (1) corrected sentences, (2) simple explanations for each correction, and (3) 3 short practice suggestions focusing on the most frequent error types. Errors: [subject-verb agreement: ‘I has a book.’ to ‘I have a book.’; tense: ‘Yesterday I go to the park.’to‘Yesterday I went to the park.’]”

In another embodiment, the server generates a practice-oriented prompt sentence such as:
“Please create 5 grammar practice sentences focusing on subject-verb agreement in the present simple. Provide them in a fill-in-the-blank format and then show the correct answers separately.”

By designing these prompt sentences programmatically based on structured weakness profiles and analysis target data, the server controls the generative AI model in a way that is not achievable through manual interaction. The server selects error categories, target difficulty levels, and output formats based on stored parameters and prior results. This architecture allows the server to adapt the model's behavior over time for each user without retraining the model, by leveraging dynamic prompt design and internal data structures.

The terminal acquires user input data and displays feedback. The user enters text via the terminal's keyboard or touch interface, or records audio via the microphone. The terminal converts these inputs into digital data and transmits them to the server using network protocols. The terminal receives structured feedback from the server and renders it in an interface that highlights errors, displays corrected sentences, and shows pronunciation scores. For example, the terminal may show the original sentence “She go to school every day.”, highlight “go” in a different color, and display the corrected sentence “She goes to school every day.” with a brief explanation.

In one embodiment, the terminal also provides an input area labeled as an AI tutor interface, where the user can input prompt sentences directly. For example, the user may type:
“Please check my grammar in the following sentence: ‘She go to school every day.’”
or
“Please create 5 practice questions for present simple subject-verb agreement and provide the answers.”

The terminal sends these prompt sentences to the server. The server does not simply relay them to the generative AI model. Instead, the server retrieves the user's weakness profile from the database and combines the user-originated prompt sentence with system-generated context that specifies the user's known difficulties. This combination can be realized by prefixing or appending additional instructions such as:
“This learner frequently makes subject-verb agreement errors and article usage errors. When generating explanations or exercises, focus on these points and use simple language.”

The server then constructs a new prompt sentence for the generative AI model that incorporates both the user's request and the system's contextual information. This non-trivial prompt construction yields responses that are more targeted and efficient than generic responses, thereby improving learning effectiveness and reducing unnecessary token processing by the model.

From a technical perspective, the server's architecture improves computer functionality compared to conventional systems in several ways. First, by forcing the generative AI model to output structured data instead of unstructured explanatory text, the server enables efficient machine parsing and aggregation. This reduces computational overhead associated with natural language parsing and avoids ambiguity. The server can update weakness profiles using simple deterministic operations on structured fields, which improves processing speed and reliability.

Second, the server integrates speech recognition and pronunciation evaluation into the same pipeline as grammar and vocabulary analysis. The server uses alignment between character string data and audio features to identify word-and phoneme-level errors, and stores these errors in the same weakness profile data structure as text-based errors. This unified representation allows the server to generate cross-modal feedback, such as combining a grammar correction with a pronunciation hint for the same word. Because the server controls these modules through specific data flows and shared identifiers, the architecture reduces redundant computations, avoids inconsistent state, and allows caching and incremental updates of the weakness profile.

Third, the server uses algorithmic rules to select which error categories to emphasize in subsequent analyses and feedback. For example, the server may assign weights to error categories based on occurrence frequency, recent changes, and severity scores. The server then uses these weights to adjust parameters in prompt construction, such as requesting more detailed explanations for high-weight categories and shorter feedback for low-weight categories. This mechanism improves the efficiency of interactions with the generative AI model by focusing computational resources on the most impactful areas, which reduces overall token usage and response latency.

Fourth, the server implements analysis logic that differs from human manual review. The server does not simply emulate a human tutor's subjective choices. Instead, the server applies non-human heuristics and thresholds, such as numeric frequency thresholds for promoting an error category to “major weakness” status, or statistical measures across a population of users to determine adaptive difficulty levels. The server may also employ non-linear update rules for the weakness profile, where error counts decay over time or are weighted by recency. These rules are implemented as explicit algorithms and yield a dynamic representation of user weaknesses that is continuously optimized for machine processing.

The generative AI model itself is configured with explicit parameters for temperature, maximum token count, and decoding strategy (for example, greedy decoding or top-k sampling) to achieve predictable and consistent behavior. The server sets these parameters differently depending on task type. For example, the server may use a low temperature and greedy decoding for grammar correction tasks to maximize determinism, while using a higher temperature and sampling for creative exercise generation. This parameter control is part of the technical implementation, reducing noise and improving reproducibility in the model's outputs, which in turn simplifies the parsing and aggregation processes.

In one alternative embodiment, the generative AI model is hosted on the same server as the application logic, and the processor directly executes the model's inference computations using specialized hardware such as graphics processing units or tensor accelerators. In this case, the server loads the model weights from the storage device into accelerator memory and performs inference locally. The server implements batched inference, where multiple user requests are grouped and processed together, improving throughput and reducing average latency. The same structured prompt design and output parsing are applied, but the internal data flow includes explicit tensor operations, matrix multiplications, and attention weight computations in the neural network layers.

In another embodiment, the speech recognition and audio evaluation functions are integrated into a single model that performs joint recognition and pronunciation scoring. The server receives audio data from the terminal, extracts acoustic features, and feeds them into the joint model. The model outputs both recognized text and phoneme-level confidence scores in a single inference step. This integration reduces round-trip communication and duplicated feature extraction, thereby lowering latency and computational resource consumption. The server then uses the recognized text as analysis target data and the phoneme scores as evaluation results without requiring separate models.

In another variation, the weakness profile is stored as a graph structure, in which nodes represent error categories and edges represent relationships between categories, such as co-occurrence or prerequisite relations. The server updates edge weights based on observed co-occurrence of errors in the same submission. The server then uses graph algorithms to identify clusters of related weaknesses and to choose sequences of practice topics. The server encodes the selected clusters into prompt sentences, thereby guiding the generative AI model to propose practice items that span connected error types rather than isolated ones. This leads to a more coherent and technically optimized curriculum for the user.

The causal relationship between the described processing and technical effects can be summarized as follows. By designing prompt sentences that enforce structured output from the generative AI model, the server enables simple, deterministic parsing and aggregation, which improves processing speed, reduces errors in weakness profiling, and lowers computational complexity relative to natural language parsing. By unifying text and audio analysis into a single data structure for weakness profiling, the server allows consistent multi-modal feedback generation and avoids duplicated processing, which decreases overall processing time and memory usage. By algorithmically controlling prompt content and model parameters based on accumulated user data and system state, the server increases the effectiveness and efficiency of each model invocation, thereby reducing redundant computation and improving responsiveness. These improvements relate directly to the operation of the computer system itself, rather than merely automating human teaching behavior.

The user interacts with the system continuously. The user provides language data, receives detailed and adaptive feedback, and optionally submits prompt sentences for additional practice. The terminal and server collaborate to process these interactions using the hardware and software components described above. Because the server updates and uses structured weakness profiles, the system's behavior changes over time in a technically controlled manner, allowing optimized allocation of computational resources and improved learning support. The described embodiments can be applied to various natural languages, various types of terminals, and various deployment environments, and can be modified or extended while remaining within the scope of the claims.

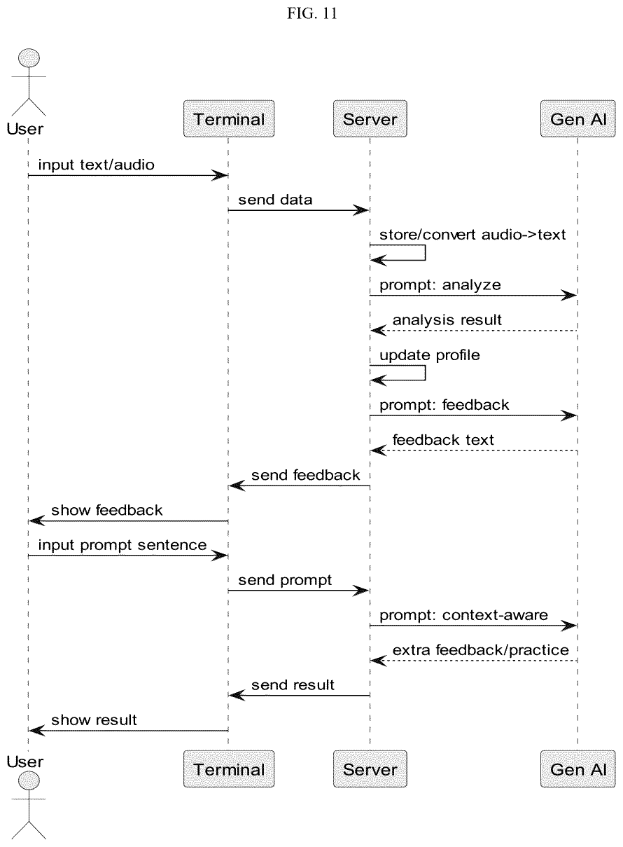

The following describes the processing flow using FIG. 11.

### Step 1

The user inputs language data on the terminal.

The user types an English sentence using a keyboard or touch screen, or records spoken English using a microphone of the terminal. The terminal receives this input as raw text or as audio samples. As input, the terminal obtains keystroke events or audio waveform data from input hardware. The terminal converts these inputs into digital representations, such as a UTF-8 text string for typed input or a PCM-encoded audio buffer for spoken input, and stores them in a local buffer. As output, the terminal produces normalized language data (text string or audio file object) that is ready to be transmitted to the server.

### Step 2

The terminal transmits the language data to the server.

The terminal receives the normalized language data from its local buffer as input. The terminal packages this data into a network request, for example by embedding text into a JSON payload or attaching audio as a binary file in a multipart/form-data message. The terminal adds metadata such as user identifier, timestamp, and data type flag (text or audio). The terminal then opens a secure communication channel using a network stack and sends the request to an application endpoint on the server. As output, the terminal produces an outbound request over the network that encapsulates the user's language data and metadata.

### Step 3

The server receives and stores the raw language data.

The server uses its network interface and web server software to accept the incoming request from the terminal as input. The server parses HTTP headers and the body, extracts the language data, and identifies whether it is text or audio using the data type flag. The server then validates the format (for example, checks encoding for text or sampling rate and file type for audio). The server writes the validated data into persistent storage, such as a database record or a file system, and assigns an internal submission identifier. As output, the server produces a stored submission entry containing raw language data, metadata, and a unique identifier.

### Step 4

The server converts audio data into character string data when necessary.

The server reads the stored submission entry as input and determines whether the language data is audio. When the language data is audio, the server passes the audio file path or buffer to a speech recognition module. The speech recognition module processes the audio frames to extract acoustic features and applies a recognition algorithm to generate a text transcription. The server receives the recognized text string from the speech recognition module. The server associates this text with the submission identifier and updates the corresponding database record to include the character string data. As output, the server produces analysis target data in text form that is derived from the original audio.

### Step 5

The server selects analysis target data and prepares a prompt sentence for the generative AI model.

The server reads either the original text data or the converted character string data from the storage as input and designates it as analysis target data. The server optionally retrieves the user's existing weakness profile to use as context. The server then constructs a prompt sentence that describes the analysis task to the generative AI model, specifies the required structured output format, and embeds the analysis target data. For example, the server may generate:
“You are an English language tutor. Analyze the following learner sentence, identify all grammatical errors and inappropriate word usage, provide corrections, and briefly explain each correction. Return the result in a structured format. Sentence: ‘I has a book.’”

The server concatenates task instructions and the analysis target data into a single instruction string. As output, the server produces a fully formed prompt sentence ready to be sent to the generative AI model.

### Step 6

The server sends the prompt sentence to the generative AI model and obtains analysis results.

The server uses the constructed prompt sentence as input to a generative AI model client module. The server forms an API request including the prompt sentence and model parameters such as temperature and maximum token count. The generative AI model processes the prompt using an internal neural network, computes token probabilities, and generates a response that describes identified errors, corrections, and explanations in a structured textual form. The server receives the response string from the model-serving endpoint. The server then parses the response according to the predefined structure, extracting fields such as error category, original fragment, corrected fragment, and explanation. As output, the server produces a structured analysis result object that can be stored and further processed.

### Step 7

The server performs pronunciation and accent evaluation for audio submissions.

The server uses the original audio data and the associated character string data as input when the submission includes audio. The server forwards these to an audio evaluation function, which extracts acoustic features and aligns them with target phoneme sequences. The audio evaluation function calculates scores for each phoneme and word, detects deviations from reference pronunciation, and assigns labels such as “incorrect vowel length” or “misplaced stress.” The server receives these evaluation results as structured data containing per-segment scores and error labels. The server stores these results in the database linked to the submission identifier. As output, the server produces a pronunciation evaluation record that details pronunciation and accent quality at word and phoneme levels.

### Step 8

The server updates a weakness profile using analysis and evaluation results.

The server reads the structured analysis result object and pronunciation evaluation record from storage as input, along with the user's existing weakness profile. The server iterates over each detected error, determines its error category (for example, subject-verb agreement, article misuse, word choice, vowel pronunciation, consonant omission), and increments corresponding counters in the weakness profile. The server may apply weighting rules or decay functions based on recency and severity scores. The server then writes the updated weakness profile back to the storage device, replacing or augmenting previous values. As output, the server produces an updated weakness profile that captures the user's current error distribution across grammar, vocabulary, and pronunciation categories.

### Step 9

The server constructs a feedback-oriented prompt sentence for the generative AI model.

The server uses the analysis target data and the updated weakness profile as input. The server aggregates typical errors and their categories into a concise summary. The server then generates a feedback-oriented prompt sentence that instructs the generative AI model to produce user-facing feedback, including corrected sentences, simple explanations, and focused practice suggestions. For example, the server may create:
“You are an English tutor. Based on the following learner sentences and their errors, generate feedback suitable for a learner. Include corrected sentences, simple explanations, and 3 short practice suggestions focusing on the most frequent error types. Errors: [subject-verb agreement: ‘I has a book.’to ‘I have a book.’]”

The server formats this text according to the model API's requirements. As output, the server produces a second prompt sentence that encodes feedback generation instructions.

### Step 10

The server invokes the generative AI model to generate feedback data.

The server sends the feedback-oriented prompt sentence to the generative AI model as input using the model client module. The generative AI model processes the instructions and generates natural language feedback adapted to the specified weaknesses, including corrected examples and recommendations. The server receives the generated text from the model-serving API. The server splits the feedback into logical sections such as grammar feedback, vocabulary feedback, and pronunciation hints, based on markers or keywords in the generated content. The server encapsulates these sections into a feedback data structure suitable for presentation. As output, the server produces feedback data that is structured for display on the terminal.

### Step 11

The server transmits the feedback data to the terminal.

The server uses the feedback data structure as input to a response module. The server serializes the feedback into a response message, for example as a JSON object containing original sentences, corrections, explanations, and pronunciation scores. The server sets appropriate protocol headers and sends the response back to the terminal over the network. As output, the server produces a network response that delivers the feedback data to the terminal associated with the user.

### Step 12

The terminal displays the feedback to the user.

The terminal receives the response from the server as input through its communication module. The terminal parses the response data to separate elements such as original text, corrected text, explanations, and pronunciation scores. The terminal updates its user interface to display the original sentence alongside its corrected version, highlight erroneous segments, and show explanations and scores in readable form. The terminal may also render interactive elements, such as buttons to replay audio or to view more detailed explanations. As output, the terminal presents visual and auditory feedback that the user can perceive and use for learning.

### Step 13

The user submits a prompt sentence for additional analysis or practice.

The user observes the displayed feedback on the terminal and decides to request further assistance. The user inputs a new prompt sentence via a text field, such as “Please check my grammar in the following sentence: ‘She go to school every day.’” or “Please create 5 practice questions for present simple subject-verb agreement and provide the answers.” The terminal collects these keystrokes as input events and constructs a unified text string. The terminal may also attach existing session information. As output, the terminal generates a user-originated prompt sentence ready to be sent to the server.

### Step 14

The terminal sends the user-originated prompt sentence to the server.

The terminal uses the user-originated prompt sentence as input, wraps it in a request payload along with user identification and session context, and transmits it to an API endpoint on the server. The terminal uses network protocols to ensure secure delivery. As output, the terminal provides the server with a new request that contains the user's explicit instruction for additional analysis or practice.

### Step 15

The server generates a context-aware prompt sentence for the generative AI model based on the user-originated prompt and the weakness profile.

The server receives the request from the terminal and parses it to extract the user-originated prompt sentence as input. The server retrieves the current weakness profile of the user from the storage. The server then programmatically combines the user-originated prompt with information extracted from the weakness profile, such as dominant error categories and preferred difficulty levels. The server constructs a third prompt sentence that includes both the user's request and system-generated guidance, for example:
“This learner often makes subject-verb agreement errors. Please check the following sentence and focus on subject-verb agreement in your explanation. Sentence: ‘She go to school every day.’”

The server formats this combined instruction string for the generative AI model. As output, the server produces a context-aware prompt sentence tailored to the user's historical weaknesses.

### Step 16

The server obtains additional feedback or practice problems from the generative AI model and returns them to the user.

The server sends the context-aware prompt sentence to the generative AI model as input. The generative AI model generates output that includes corrected sentences, focused explanations, or newly created practice questions consistent with the supplied context. The server receives this generated output, parses it where necessary, and packages it as additional feedback or practice problem data. The server then sends this data back to the terminal using the same network mechanism as previous responses. As output, the server provides enriched and personalized learning content driven by both the user's immediate request and accumulated weakness information.

### Step 17

The terminal presents the additional feedback or practice problems and allows iterative interaction.

The terminal receives the additional feedback or practice problems from the server as input, parses the data, and updates its interface to display new corrections, explanations, or interactive questions. The user views the new content, answers questions, or submits further prompt sentences. The terminal collects the user's interactions and can send new language data or new prompt sentences to the server. As output, the terminal enables a continuous cycle of input, analysis, feedback, and practice, driven by the coordinated processing between the server, the generative AI model, and the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented language learning systems typically apply fixed rule-based checks or static item banks to evaluate user input and to present feedback. These systems often rely on predefined grammar rules, simple pattern matching, or limited scoring heuristics that operate independently of the user's longitudinal learning history. As a result, such systems frequently fail to generate context-aware and user-specific feedback, to identify weaknesses coherently across multiple language skill dimensions, or to adapt content selection in real time on the basis of evolving user performance.

In particular, known systems have several technical shortcomings. First, they generally do not integrate outputs from a generative AI model into a structured, machine-readable representation that can drive downstream computation such as weakness indexing, scoring, and adaptive resource selection. The model output is often treated as unstructured natural language text and merely displayed to the user, without systematic parsing, aggregation, or time-series analysis by the computer system. This limits the ability of the processor to compute meaningful, multi-dimensional performance indicators and to automate the control flow of subsequent teaching actions.

Second, conventional systems typically do not employ prompt control mechanisms that allow the processor to programmatically direct a generative AI model to produce outputs in formats optimized for machine processing. Without explicit prompt sentences defining required fields, error categories, and output structures, the system tends to receive inconsistent responses that are poorly suited for automated analysis. As a consequence, the server-side components cannot reliably map model outputs to technical constructs such as structured weakness indices, proficiency levels, or resource-selection parameters, thereby reducing robustness and scalability of the overall system.

Third, existing language learning platforms generally do not maintain and utilize detailed time-series records of user weaknesses and proficiency levels as first-class data structures in the core processing pipeline. While some systems store scores or completion records, they do not systematically feed the historical performance data back into the prompt sentences supplied to the generative AI model. Therefore, the AI model cannot condition its analysis and content generation on the user's prior learning trajectory, and the processor cannot dynamically adjust resource types and difficulty levels on the basis of quantified temporal changes in user performance metrics. This leads to inefficient learning paths, redundant exercises, and suboptimal allocation of computational resources.

Fourth, many implementations treat speech input and text input as separate workflows, and do not consistently normalize speech data into a unified character-based representation suitable for integrated analysis. When audio data is not systematically converted by a dedicated audio-processing component into character information linked with recognition confidence or phoneme-level information, the server cannot uniformly apply its analysis, indexing, and selection logic across both spoken and written inputs. This fragmentation degrades the ability of the system to construct holistic weakness indices that span sentence structure, listening, speaking, and vocabulary fields.

Accordingly, there is a need for an improved computer-implemented system and server-side architecture that (i) acquires user language information in multiple modalities, (ii) controls a generative AI model through explicitly designed prompt sentences to obtain structured, machine-readable analysis, (iii) computes multi-dimensional weakness indices and proficiency levels from the structured analysis, (iv) maintains time-series records of such indices and levels in a storage device, and (v) dynamically selects and presents learning resources and feedback content adapted to the evolving state of each user. Such a system should improve the technical functioning of the computer-based learning platform by enabling more reliable automated parsing, storage, and reuse of AI-generated information, and by increasing the efficiency and responsiveness of adaptive content delivery.

The specific processing by the specific processing unit 290 of the data processing device 12 in Application Example 1 is realized by the following means.

The present invention provides a server comprising a processor and at least one storage device, wherein the processor is configured to acquire language information from a user via an input/output device, the language information including at least one of character information and sound information; to convert, when the sound information is acquired, the sound information into character information by using an audio-processing component and to store a conversion result as the language information of the user in the storage device; to supply the language information of the user to a generative AI model while generating and providing to the generative AI model a prompt sentence that programmatically specifies an output structure and error categories as auxiliary information for inputting the language information into the generative AI model, and to cause the generative AI model to analyze language ability of the user; to parse an output result obtained from the generative AI model in accordance with the specified structured output format, to calculate, for each of multiple skill fields including at least a sentence structure field, a listening field, a speaking field, and a vocabulary field, at least one of a type and a frequency of an error, and to generate a weakness index corresponding to each of the fields as machine-processable performance data stored in the storage device; to estimate a proficiency level of the user based on the weakness index and past learning history information of the user stored as time-series information in the storage device, and to select a target learning resource from among a plurality of learning resources stored in a resource storage region in accordance with the proficiency level and the weakness index of each field; to generate a further prompt sentence for the generative AI model that includes at least one of the weakness index, the proficiency level, and a subset of the time-series information so as to cause the generative AI model to produce feedback information including at least one of a corrected expression, an explanatory expression, a practice task, and a dialog text for conversation practice related to a weakness of the user, based on contents of the selected learning resource and the analysis output; and to present, via the input/output device, the feedback information and the selected learning resource to the user and, in response to new language information from the user, to repeatedly perform the analyzing, updating of the weakness index, updating of the proficiency level, storing of the time-series information, and selection of the learning resource. This enables the computer-implemented system to control the generative AI model through explicit prompt sentences to obtain structured, machine-readable analysis results, to maintain and exploit time-series performance data as internal state, and to dynamically adapt feedback generation and resource selection in real time, thereby improving the technical functioning of the server by enhancing robustness, scalability, and responsiveness of automated language learning operations.

The term “processor” refers to a hardware-based information processing unit, such as a central processing unit or a processing core, that executes program instructions to perform operations including acquisition, analysis, storage, and output of data in the system.

The term “storage device” refers to a non-transitory computer-readable medium, such as a semiconductor memory, magnetic storage, or optical storage, that stores program code, user data, learning resources, and time-series performance information used by the processor.

The term “input/output device” refers to a hardware interface, such as a display, a touch panel, a keyboard, a pointing device, a microphone, a speaker, or a communication interface, through which the system exchanges information with a user.

The term “user” refers to an operator or learner who interacts with the system by providing language information and by receiving feedback information and learning resources from the system.

The term “language information” refers to data representing a natural language expression of the user, including at least one of character information that encodes written language and sound information that encodes spoken language.

The term “character information” refers to digital data representing linguistic content in the form of characters, symbols, or text strings suitable for processing by text-based algorithms and models.

The term “sound information” refers to digital audio data representing an acoustic signal of spoken language, including, for example, sampled waveforms of the user's speech.

The term “audio-processing component” refers to a hardware or software module that processes sound information, including converting audio signals into character information using speech recognition or similar techniques.

The term “conversion result” refers to character information obtained by transforming sound information into textual form, such as a transcript of spoken language generated by the audio-processing component.

The term “generative AI model” refers to a trained computational model, such as a neural network-based generative language model, that receives input data and a prompt sentence and generates output data including analyses, corrections, and content in natural language or structured formats.

The term “prompt sentence” refers to a sequence of characters or text instructions supplied to the generative AI model to specify a task, an output structure, an error category set, or other constraints that control the behavior and format of the model's output.

The term “auxiliary information” refers to additional control data, including at least one prompt sentence, provided together with user language information to the generative AI model in order to influence the content and structure of the generated output.

The term “output result” refers to data generated by the generative AI model in response to the supplied language information and prompt sentence, including at least one of explanations, corrections, classifications, and other derived information.

The term “structured output format” refers to a predefined arrangement of fields, labels, or data types, such as a list structure or a machine-readable format, that specifies how the output result of the generative AI model is to be organized for parsing and further computation.

The term “sentence structure field” refers to a skill dimension related to syntactic correctness and grammatical organization of sentences, including word order, verb forms, and use of function words.

The term “listening field” refers to a skill dimension related to comprehension and processing of spoken language, including recognition of words and phrases from sound information provided to or by the user.

The term “speaking field” refers to a skill dimension related to production and articulation of spoken language, including pronunciation, stress, intonation, and fluency characteristics.

The term “vocabulary field” refers to a skill dimension related to choice, range, and appropriateness of lexical items, including correct word selection and usage in context.

The term “error type” refers to a classification category assigned to an error detected in language information, such as an error in tense, article usage, word order, pronunciation, or lexical choice.

The term “error frequency” refers to a quantitative measure of how often a particular error type occurs in the user's language information over a specified set of inputs or time period.

The term “weakness index” refers to a numerical or categorical performance indicator generated for each skill field based on at least one of error type and error frequency, and stored as machine-processable data for subsequent analysis and adaptation.

The term “proficiency level” refers to an overall or field-specific indication of the user's language competence, represented as an ordered scale or category determined from one or more weakness indices and learning history information.

The term “learning history information” refers to accumulated data describing the user's past interactions with the system, including previous inputs, weakness indices, proficiency levels, and learning resources presented, organized in a time-series manner.

The term “time-series information” refers to information that records changes of at least one of weakness indices and proficiency levels over time, enabling temporal analysis of the user's learning progress.

The term “learning resource” refers to digital instructional content stored in the system, including at least one of example texts, exercises, quizzes, audio materials, and dialog materials, which are selected and presented to support improvement in one or more skill fields.

The term “resource storage region” refers to a portion of the storage device or a logically associated storage system that holds a plurality of learning resources indexed by attributes such as skill field, difficulty level, and resource type.

The term “feedback information” refers to information generated for presentation to the user based on the analysis output, weakness indices, proficiency level, and selected learning resources, including at least one of corrected expressions, explanatory expressions, practice tasks, and dialog texts.

The term “corrected expression” refers to a revised linguistic expression generated to replace or improve an erroneous or suboptimal user expression, such as a grammatically corrected sentence.

The term “explanatory expression” refers to a descriptive or instructional text explaining the reason for a correction, an error, or a recommended usage, intended to help the user understand the underlying rule or concept.

The term “practice task” refers to an interactive exercise or question, such as a fill-in-the-blank item, transformation exercise, or comprehension question, generated or selected to target a specific weakness index.

The term “dialog text” refers to a sequence of utterances or turns in a simulated conversation, provided for the user to practice speaking or writing in a communicative context.

The term “machine-readable format” refers to a data representation, such as a structured text, markup, or serialized object, that is directly parsable and processable by a program executed by the processor without requiring manual interpretation.

The term “difficulty level” refers to a classification attribute of a learning resource that indicates its relative complexity, such as required vocabulary range, grammatical complexity, or speed of spoken language, and is used to match resources to the user's proficiency level.

The term “type of learning resource” refers to a categorical attribute describing the functional or modal class of a learning resource, such as grammar exercise, listening material, pronunciation drill, or dialog practice content.

In one embodiment, a server provides a language learning system that cooperatively operates with one or more terminals used by a user. The server includes at least one processor, a main memory, a non-transitory storage device, and a network interface. The processor executes program instructions stored in the storage device to implement the functions described below. The terminal includes at least one processor, a display device, an audio input device such as a microphone, an audio output device such as a speaker or earphone, a pointing device or touch panel, and a communication module such as a wireless transceiver.

The server configures its hardware and software environment as follows. The server uses a general-purpose computing platform, for example a rack-mounted computer with a multi-core central processing unit, a graphics processing unit, a volatile main memory, and a solid-state drive. The server runs an operating system such as a Unix-like operating system. The server executes a web application framework such as a scripting-language-based framework or a virtual-machine-based framework for handling Hypertext Transfer Protocol Secure (HTTPS) requests from the terminal. The server connects to a relational database management system such as a structured query language database for storing user profiles, time-series weakness indices, proficiency levels, and metadata of learning resources. The server also connects to an object storage service or local file system for storing audio files and learning contents.

The terminal runs an operating system such as a mobile operating system or a desktop operating system. The terminal executes an application implemented, for example, as a native mobile application or a web-based application running in a browser. The terminal application includes program components for capturing text input through a keyboard or touch panel, capturing audio through the microphone, encoding the audio as digital sound information, transmitting data to the server via HTTPS, rendering feedback information on the display, and playing audio through the speaker.

The server acquires language information from the terminal in a unified data structure designed for efficient processing. The server uses a data object that includes at least the following fields: a user identifier, a timestamp, an input modality flag (text or audio), a language code, and either a text string or a binary audio payload. When the terminal provides sound information, the terminal samples the acoustic signal at a predetermined sampling rate, for example 16 kHz, and encodes it as linear pulse-code modulation data or a compressed format such as a waveform audio file. The server receives the sound information and stores it temporarily in the storage device.

The server converts sound information into character information using an audio-processing component. In one embodiment, the server communicates with an external speech recognition service over a network. The server sends the raw audio or an encoded representation to the speech recognition service with parameters specifying the audio encoding format, sampling rate, and target language. The speech recognition service performs acoustic feature extraction, phoneme sequence decoding, and language model scoring to output character information as a transcript string, accompanied by confidence values for each recognized token. The server receives the transcript and stores it in the storage device, associated with the original audio file and confidence values. By normalizing audio input to character information, the server can apply a common analysis pipeline to both written and spoken language data.

The server provides language information and a prompt sentence to a generative AI model that is implemented as a neural network-based generative language model. In one embodiment, the generative AI model is a transformer-based model having multiple layers of self-attention, feedforward sub-layers, and layer normalization. The model is trained on large-scale corpora of text data using an autoregressive objective. The model represents input tokens as dense vectors, applies multi-head attention to capture long-range dependencies, and outputs probability distributions over vocabulary tokens for each position in a sequence. The server accesses the generative AI model through an application programming interface provided by a model-serving platform.

The server constructs a prompt sentence as an instruction to the generative AI model. The prompt sentence defines the task, required output fields, and output format. For example, the server generates a prompt sentence such as:
“Analyze the following English sentence, identify all grammatical errors, and propose the correct form. Then briefly explain each correction. Output the result as a list of errors, each containing the incorrect text, the corrected text, and a short explanation.”

The server concatenates the prompt sentence with the user's language information, for example:
“User sentence: ‘I goed to the store yesterday.’”

The server may use additional prompt sentences for different purposes. For example:
“Given the following user sentences, identify weaknesses in grammar, vocabulary, and speaking style. Classify each error by type and frequency, and propose three main focus areas for study.”
or
“Evaluate the user's overall English proficiency based on the responses below and estimate a proficiency level on a predefined scale. Then list the top three skills the user should study next.”

The server encodes the prompt sentence and the user language information into tokens and sends them to the generative AI model via the model-serving interface. The generative AI model processes the tokens using its internal transformer architecture. The model converts tokens into embeddings, applies stacked layers of attention and feedforward transformations, and generates output tokens that form an output result. The server receives the output result as a string.

The server configures the prompt sentence so that the output result conforms to a structured output format. For example, the server instructs the generative AI model to output clear field markers, headings, or delimited sections that can be reliably parsed. This differs from simply displaying unstructured explanatory text and enables the server to perform automated parsing and numerical computation. The server parses the output result using string processing logic. The server extracts error entries, each including at least an error type, the original text, the corrected text, and an explanation text. The server also extracts global fields such as an estimated proficiency level and a list of recommended focus areas.

The server computes weakness indices for multiple skill fields based on the parsed output. The server defines a data structure for weakness indices, for example a vector or record having fields for a sentence structure field, a listening field, a speaking field, and a vocabulary field. For each error entry, the server maps the error type to one or more of these fields using a mapping table stored in the database. The server increments counters for each field and each error subtype. The server then computes normalized scores, for example by dividing error counts by the number of sentences or words processed in a given session. The server stores the resulting weakness indices in the storage device as part of a time-series record for the user.

The server estimates a proficiency level based on the weakness indices and the user's learning history. In one embodiment, the server applies a rule-based algorithm that maps aggregate weakness index values to discrete proficiency levels. Alternatively, the server may train a separate classifier model, such as a logistic regression model or a shallow neural network, using historical data linking observed error patterns to expert-rated proficiency levels. The server uses as features the weakness indices per field, the number of sessions completed, and trends over time. The server outputs a proficiency level such as a coarse category or a numeric score.

The server maintains the weakness indices and proficiency levels as time-series information. The server stores, for each user and each session, the timestamp, weakness indices, proficiency level, and identifiers of the learning resources presented. This time-series structure enables the server to compute temporal derivatives, moving averages, and other statistical measures of progress. The server feeds a summary of the time-series information back into subsequent prompt sentences. For example, the server may generate a prompt sentence:
“Considering that the user has shown repeated errors in past tense verb forms and article usage over the last five sessions, generate feedback that focuses on these weaknesses and propose practice tasks that gradually increase in difficulty.”

By explicitly conditioning the generative AI model on time-series information, the server enables the model to generate feedback that is aligned with the user's learning trajectory, not just the current input.

The server selects learning resources from a resource storage region based on the weakness indices and proficiency level. The resource storage region holds metadata for each learning resource, including skill field tags, difficulty level tags, content type, and media type. The server queries the database using the weakness indices as selection parameters. For example, when the sentence structure field shows a high error frequency in past tense usage and the proficiency level is intermediate, the server searches for resources tagged as grammar, past tense, and intermediate level. The server then ranks candidate resources based on parameters such as prior effectiveness metrics or diversity constraints and selects a subset for presentation.

The server generates further prompt sentences to instruct the generative AI model to produce feedback information that integrates the analysis output and the selected learning resources. For example, the server may send the following prompt sentence:
“Based on the user's errors in the following sentences and the following example exercises, generate a set of personalized explanations and three practice tasks targeting past tense verbs. Use clear, short sentences suitable for an intermediate learner.”

The server includes in the prompt sentence sample items from the selected learning resources and a summary of the user's weaknesses. The generative AI model then generates corrected expressions, explanatory expressions, and practice tasks. The server receives and parses this output and forms feedback information.

The terminal presents the feedback information to the user. The terminal's display shows the original user sentence, the corrected expression, and an explanatory expression for each correction. The display may highlight the erroneous portion of the sentence, for example by underlining or colored marking, and may show a side-by-side comparison. The terminal also renders practice tasks, such as fill-in-the-blank questions or sentence transformation prompts, as interactive user interface elements. When audio-based feedback is available, the terminal downloads and plays audio files, allowing the user to listen to correct pronunciation or example sentences.

The server uses the described data structures and algorithms to improve technical characteristics of the system. By enforcing a structured output format through carefully designed prompt sentences and post-processing, the server reduces the need for complex, heuristic text parsing and increases robustness. This leads to fewer parsing errors, more stable numerical weakness indices, and reduced processing time per request. By maintaining time-series weakness indices and proficiency levels as integral data, the server enables efficient indexing and retrieval operations in the database, which improves data management and reduces query complexity compared to storing only unstructured logs.

The server improves computational efficiency by normalizing diverse input modalities into a common character information representation. This allows the server to reuse the same analysis and weakness computation pipeline for both text and audio inputs, reducing redundant processing modules. The server also reduces communication load by transmitting compact, structured summaries of analysis results and selected learning resources, rather than transmitting full raw outputs or entire corpora. The server can, for example, store large resource sets locally and only send resource identifiers and essential content snippets to the terminal.

The generative AI model operates under explicit prompt control that is different from conventional rule-based grammar checkers or static content generators. The server does not merely automate a human tutor's behavior, but instead uses structured prompt sentences to force the model to emit machine-readable features such as labeled error types and counts. These features are then fed into deterministic algorithms that compute weakness indices and select resources. This combination of learned generative capabilities and deterministic computation produces a data flow that is not attainable by mere human inspection or straightforward automation of manual marking.

The server improves accuracy and stability of proficiency estimation by integrating model outputs with statistical analysis over time. For example, by smoothing weakness indices using moving averages and weighting errors by recency, the server can filter out noise and transient mistakes. This leads to more consistent proficiency levels and more appropriate difficulty selection. Because the server integrates multiple feedback loops, model analysis, weakness indexing, time-series updates, and resource selection, the server can adapt more quickly to changes in user performance, which improves responsiveness and reduces unnecessary repetition of tasks.

The generative AI model in the server is trained using supervised or semi-supervised learning on corpora that include labeled corrections, proficiency annotations, and error types. During training, the model minimizes a loss function such as cross-entropy between predicted tokens and reference tokens. The model parameters are updated by gradient-based optimization algorithms. Data augmentation techniques, such as noise injection into input sentences, paraphrase generation, or synthetic error insertion, may be used to improve robustness. Although the training phase may be executed on separate computing infrastructure, the trained model parameters are deployed on the server or on a model-hosting infrastructure accessible by the server, and the server uses these parameters at inference time.

The server can be implemented in multiple alternative embodiments. In one embodiment, the generative AI model resides on the same physical hardware as the server and is invoked as a local library. In another embodiment, the generative AI model is hosted on a remote model-serving cluster, and the server communicates with the cluster via a network interface. In yet another embodiment, the server uses a smaller, on-device generative model for low-latency operations and a larger, remote model for periodic, more detailed assessments.

The terminal can also vary in configuration. In some embodiments, the terminal is a smartphone with a touch-sensitive display and integrated microphone and speaker. In other embodiments, the terminal is a head-mounted display device or a tablet, where the display of feedback information may include augmented reality overlays. The system can also operate with a desktop computer terminal or a web browser terminal.

The server can use different algorithms to map errors to weakness indices. In one embodiment, the server uses a fixed mapping table implemented as a key-value store. In another embodiment, the server uses a secondary classification model that takes as input short text descriptions of errors produced by the generative AI model and classifies them into predefined categories. This allows the server to flexibly adapt to changes in the wording of model outputs while maintaining stable weakness indices.

The described architecture focuses on technical data flows, structured prompt design, and deterministic processing of model outputs, rather than on high-level business processes. By carefully defining data structures for language information, weakness indices, time-series records, and resource metadata, and by orchestrating these data structures through explicit algorithms, the server provides a concrete technical implementation that improves processing efficiency, robustness, and adaptability of computer-based language learning systems.

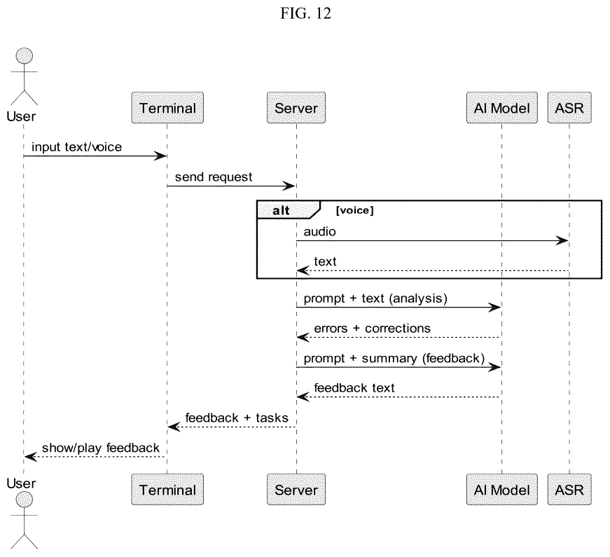

The following describes the processing flow using FIG. 12.

### Step 1

Terminal acquires user input.

Terminal displays an input screen and accepts language information from the user as either typed text or recorded speech. As input, the terminal receives keystrokes from a keyboard or touch events from a virtual keyboard when the user types a sentence, or audio samples from a microphone when the user speaks. Terminal converts the raw audio signal into digital sound information by sampling at a predetermined rate and encoding it into an audio file format. As output, the terminal generates a request payload that includes at least a user identifier, a timestamp, an input modality flag (text or audio), a language code, and either a text string or an audio file, and prepares this payload for transmission.

### Step 2

Terminal transmits language information to server.

Terminal opens a secure network connection using a communication module and sends the request payload to a server endpoint via HTTPS. As input, the terminal uses the request payload created in Step 1 and the server URL stored in its configuration. Terminal encapsulates the payload into a structured message, for example a JSON object for text input or a multipart message for audio input. As output, the terminal produces a network packet stream and transmits it over a wireless or wired network to the server, then waits for a response.

### Step 3

Server receives and normalizes language information.

Server listens on an HTTPS endpoint and receives the incoming request from the terminal. As input, the server obtains the payload containing the user identifier, modality flag, language code, and either text or audio data. Server validates the payload (for example, checks authentication tokens and content size) and writes a log entry into a storage device. Server then normalizes the data by encapsulating it into an internal data structure that includes the user identifier, input text field (initially empty for audio), raw audio field (empty for text), and metadata. As output, the server produces a unified language information record that is stored in memory and optionally persisted in the storage device.

### Step 4

Server converts audio input to character information.

Server checks the modality flag in the unified language information record. As input, the server uses records marked as audio and the associated raw audio data. Server sends the audio data to an audio-processing component, such as a speech recognition service, with parameters specifying encoding, sampling rate, and language. The audio-processing component performs feature extraction and decoding and returns a transcript and confidence values. Server receives the transcript string and confidence scores, and writes them into the input text field and an auxiliary confidence field of the language information record. As output, the server produces an updated language information record in which all user input, whether originally text or audio, is represented as character information.

### Step 5

Server constructs prompt sentence for initial analysis.

Server prepares to query a generative AI model for analysis of the user's language. As input, the server uses the updated language information record containing the user's text, the language code, and optional metadata such as session context. Server generates a prompt sentence that defines the analysis task and required output structure, for example:
“Analyze the following English sentence, identify all grammatical errors, and propose the correct form. Then briefly explain each correction. Output the result as a list of errors, each containing the incorrect text, the corrected text, and a short explanation.”

Server concatenates this prompt sentence with the user's text, such as:
“User sentence: ‘I goed to the store yesterday.’”

Server packages these into a request object for the generative AI model, including configuration parameters such as maximum output length and temperature. As output, the server produces a model request that contains both the prompt sentence and the user's text in a format accepted by the generative AI model interface.

### Step 6

Server invokes generative AI model and obtains analysis output.

Server sends the model request to a generative AI model service through a model-serving API. As input, the generative AI model receives a tokenized representation of the prompt sentence and user text. Internally, the model converts tokens to embeddings, applies multiple transformer layers with self-attention and feedforward computations, and computes probability distributions over vocabulary tokens at each step to generate an output sequence. Server receives the generated output sequence as text when the model finishes or a stopping condition is met. As output, the server obtains an analysis output string that contains information on errors, corrections, and explanations in a structured textual layout as instructed by the prompt sentence.

### Step 7

Server parses analysis output and computes weakness indices.

Server processes the analysis output string to extract machine-usable data. As input, the server uses the analysis output from the generative AI model. Server applies string parsing procedures, such as splitting by line breaks or markers, and identifies sections indicating error type, original expression, corrected expression, and explanation. Server builds an error list where each entry contains at least an error category label, a location in the user text, and the corrected form. Server then maps each error category to one or more skill fields (sentence structure, listening, speaking, vocabulary) using a mapping table stored in the storage device. For each field, server counts occurrences of related error types and calculates error frequencies, for example dividing error counts by the number of tokens or sentences. As output, the server produces a weakness index vector, where each component represents a numerical indicator for a specific skill field.

### Step 8

Server updates time-series performance data and estimates proficiency level.

Server records the current session's performance in persistent storage. As input, server uses the weakness index vector, the user identifier, and a timestamp. Server inserts or updates a time-series record in the storage device, appending the new weakness indices and linking them with any previous records. Server then retrieves historical weakness indices and any stored proficiency levels for the same user using database queries. Server applies an aggregation algorithm, such as computing moving averages or weighted sums, to derive smoothed performance metrics per field. Based on these metrics and optionally the analysis output (for example, an explicit level suggestion), server estimates a proficiency level by applying rule-based thresholds or a trained classifier model. As output, the server produces an updated proficiency level for the user and an updated time-series record stored in the storage device.

### Step 9

Server selects appropriate learning resources.

Server determines which learning materials to present next. As input, the server uses the weakness index vector, the proficiency level, and metadata of available learning resources stored in a resource storage region. Server formulates a query specifying filters for skill fields with high weakness indices, a target difficulty range around the proficiency level, and content types appropriate for the detected issues (for example, grammar exercises for sentence structure errors, pronunciation drills for speaking issues). Server executes this query against the resource metadata using a database system and retrieves a candidate set of learning resources. Server then ranks or filters the candidates based on additional criteria such as diversity or past effectiveness for the user. As output, the server generates a selected learning resource set that includes identifiers, text content, and any associated media references.

### Step 10

Server constructs prompt sentence for personalized feedback generation.

Server prepares a second query to the generative AI model to generate user-specific feedback and practice tasks. As input, the server uses the error list from the analysis output, the weakness index vector, the proficiency level, and content snippets from the selected learning resources. Server composes a prompt sentence such as: “Based on the user's errors in the following sentences and the example exercises, generate personalized explanations and three practice tasks targeting past tense verbs. Use clear, short sentences suitable for the user's current level.”

Server appends the user's original sentences, a concise summary of errors, and selected example items to the prompt sentence. Server packages this data into a request object for the generative AI model, including settings to ensure the output contains corrected expressions, explanatory expressions, and clearly labeled tasks. As output, the server generates a feedback request to be sent to the generative AI model.

### Step 11

Server obtains and structures feedback information.

Server sends the feedback request to the generative AI model service. As input, the generative AI model receives the prompt sentence plus the error summary and example items and processes them with its neural network architecture. The model generates an output that includes corrected sentences, explanations, and descriptions of practice tasks. Server receives this output text and parses it using similar structured parsing techniques as in the analysis phase, identifying segments corresponding to corrected expressions, explanations, and task descriptions. Server forms a feedback information object that organizes these elements into fields that can be directly rendered by the terminal. As output, the server produces a structured feedback information object linked to the selected learning resources.

### Step 12

Server returns feedback information and learning resources to terminal.

Server prepares a response message to the terminal. As input, the server uses the structured feedback information, the selected learning resources, and any updated performance indicators that should be shown to the user, such as a summary of skill focus areas. Server serializes this information into a response format, for example a JSON object containing fields for original sentence, corrected sentence, explanation text, practice tasks, resource texts, and media URLs. Server sends this response back to the terminal over the established HTTPS connection. As output, the server produces a network response that carries all data needed for user interaction in the next learning cycle.

### Step 13

Terminal renders feedback and collects next user interaction.

Terminal receives the response from the server. As input, the terminal uses the JSON or similar structured data containing feedback information and learning resources. Terminal parses the data and updates the user interface, displaying the original and corrected sentences side by side, rendering explanations beneath the relevant text segments, and showing practice tasks as interactive components such as multiple-choice items or text entry fields. Terminal also downloads any referenced audio files and plays them through the speaker when the user initiates playback. Terminal monitors user interactions with the practice tasks, capturing new typed answers or additional speech recordings as the user responds. As output, the terminal generates new language information and interaction data, which will be packaged into a new request payload when the user submits the responses.

### Step 14

User studies feedback and provides additional input.

User reads the corrected sentences and explanatory texts presented on the terminal's display. As input, the user receives visual information, audio information, and task descriptions. User thinks about the explanations, repeats example sentences aloud while listening to audio prompts, and completes practice tasks by selecting options or typing new sentences. User may speak additional utterances into the microphone to practice pronunciation or spontaneous conversation. As output, the user produces new language expressions in text or speech, which the terminal captures and sends to the server, causing the entire cycle of analysis, weakness index computation, resource selection, and feedback generation to repeat.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented learning support systems typically provide static or rule-based feedback that is weakly tied to actual user performance data. In many implementations, a server merely logs scores and presents pre-authored hints or generic explanations, without deeply analyzing user-specific error patterns or dynamically adapting content. As a result, such systems fail to effectively utilize the available computing resources and data processing capabilities to generate truly personalized and context-aware feedback.

Moreover, known systems that employ machine learning models or generative models often treat these components in isolation. A machine learning model may be used to recommend learning materials, while a generative model may independently generate explanations, but there is no structured integration of statistical analysis, predictive estimation, and prompt-controlled text generation in a unified computational pipeline. This disjointed design leads to inefficient use of computational resources, difficulty in maintaining system behavior, and limited controllability over the generative output. In particular, the lack of a well-defined interface between predictive models and generative models prevents the server from reliably generating feedback that is precisely aligned with detected weaknesses and selected materials.

Further, many systems rely on ad hoc or unstructured input to the generative model. Without a rigorously constructed prompt sentence that encodes analysis results, weakness information, and material recommendations in a machine-controlled format, the generative model may produce inconsistent or overly verbose feedback, thereby increasing computational overhead and degrading the user experience. The absence of a standardized tabular data representation also hampers efficient large-scale statistical analysis and makes it difficult to compute robust indicators such as error rates, score distributions, and learning trends.

Accordingly, there is a need for an improved computer-implemented learning support technique in which a server utilizes a structured data processing pipeline to (i) acquire and store learning data, (ii) perform statistical analysis using tabular data structures, (iii) estimate effectiveness of learning materials using a machine learning model, and (iv) generate controlled prompts for a generative AI model, so that the generative output is constrained and guided by computed weaknesses and recommended materials. This improvement should enhance the functioning of the computer system itself by optimizing data flows, reducing unnecessary interactions, and enabling reproducible and predictable behavior of the combined machine learning and generative components.

The specific processing by the specific processing unit 290 of the data processing device 12 in Example 2 is realized by the following means.

The present invention provides a server comprising a processor and a storage device, wherein the processor is configured to acquire learning data from a user via a terminal device and store the learning data as accumulated information in the storage device; obtain the learning data from the storage device and statistically analyze the learning data by using a data processing program and a tabular data structure to generate an analysis result indicating candidate weaknesses of the user; generate feature data based on the analysis result and a learning history of the user and process the feature data as input to a machine learning model to calculate an estimation result indicating effectiveness values for a plurality of learning material candidates; select recommended learning materials from the learning material candidates based on the estimation result and generate a prompt sentence including information on the candidate weaknesses and information on the recommended learning materials; input the prompt sentence into a generative AI model and obtain output data from the generative AI model, the output data including feedback information corresponding to the weaknesses of the user and the recommended learning materials; and convert the output data and the information on the recommended learning materials into user interface data and transmit the user interface data to the terminal device to cause the terminal device to display the user interface data. This enables the server to implement an integrated and technically improved processing pipeline in which structured statistical analysis, predictive estimation, and prompt-controlled generative processing are combined to efficiently produce personalized feedback, thereby enhancing the overall operation of the computer system and improving the quality and consistency of the generated feedback while reducing unnecessary computational overhead.

The term “learning data” refers to information representing a user's learning activities, including but not limited to test scores, correctness of answers, question identifiers, timestamps, and any other performance indicators collected during learning tasks.

The term “terminal device” refers to an electronic apparatus operated by a user, such as a portable information device, a stationary computing device, or any other user-side computing equipment capable of inputting data and displaying information received from a server.

The term “storage area” refers to a logical or physical memory region provided by a storage device in which data, including learning data and analysis results, are stored in a non-transitory manner for later retrieval and processing by a processor.

The term “accumulated information” refers to learning data that has been persistently stored in the storage area over time, including multiple records of user performance and related metadata used for analysis and model processing.

The term “data processing program” refers to software instructions executable by a processor to perform operations on data, such as reading, writing, filtering, aggregating, and transforming learning data for analysis.

The term “tabular data structure” refers to a data representation in which data is organized in rows and columns, such as a table or data frame, enabling indexed access, grouping, aggregation, and other structured data operations.

The term “analysis result” refers to data generated by the processor through statistical or logical processing of learning data, including identified patterns such as error rates, score distributions, and candidate weaknesses of a user.

The term “candidate weaknesses” refers to aspects of a user's knowledge or skills that are inferred, based on analysis of learning data, to be relatively weak or in need of improvement, such as specific topics, categories, or item types associated with low performance.

The term “learning history” refers to a collection of past learning data associated with a user, including previous tests, exercises, sessions, and interactions, together with temporal information indicating progression over time.

The term “feature data” refers to numerical or categorical representations derived from learning data, analysis results, and learning history, which are formatted in a manner suitable for input to a machine learning model.

The term “machine learning model” refers to a computational model that has been trained using data to perform tasks such as prediction, classification, or regression, and that accepts feature data as input and outputs estimation results regarding effectiveness of learning materials.

The term “estimation result” refers to an output produced by the machine learning model, indicating predicted effectiveness, relevance, or suitability for a plurality of learning material candidates in relation to a user's weaknesses and learning history.

The term “learning material candidate” refers to a unit of instructional content, such as a document, exercise, multimedia item, or lesson, that is registered in a content database and is considered as a potential recommendation for a user.

The term “recommended learning materials” refers to one or more learning material candidates selected by the processor based on the estimation result, which are determined to be suitable for addressing the user's weaknesses.

The term “prompt sentence” refers to a text string or structured natural language input generated by the processor, which encodes information about candidate weaknesses, recommended learning materials, and desired output specifications, and which is provided as input to a generative AI model.

The term “generative AI model” refers to a computational model capable of generating output data, such as text, based on input prompts, and implemented, for example, as a neural network that produces natural language feedback conditioned on the prompt sentence.

The term “output data” refers to information returned from the generative AI model in response to a prompt sentence, including feedback information, explanations, study plans, or other generated content tailored to a user's weaknesses and recommended learning materials.

The term “feedback information” refers to content provided to a user for learning support, including explanations, recommendations, study strategies, and guidance that are generated or selected to address the user's weaknesses.

The term “user interface data” refers to formatted information suitable for presentation on a terminal device, including layout structures, text, links, and other elements derived from output data and recommended learning materials.

The term “communication device” refers to a hardware or software component that enables data transmission between a server and a terminal device via a communication network using one or more communication protocols.

The term “data processing library” refers to a software component or collection of functions providing capabilities for handling tabular or structured data, such as loading, transforming, aggregating, and analyzing data within a program.

The term “error rate” refers to a statistical indicator representing a ratio or proportion of incorrect answers or failures relative to a total number of attempts or items for a given topic, category, or period.

The term “score distribution” refers to a representation of how scores are spread across a set of learning activities, such as a distribution of numeric scores over multiple tests, items, or time intervals.

The term “learning trend” refers to a pattern or change over time in a user's learning performance, such as improvement, stagnation, or decline, inferred from temporal analysis of the user's learning history.

The term “structured data” refers to data that is organized according to a predefined format or schema, such as key-value pairs, tables, or objects, allowing systematic parsing and reliable input to machine learning or generative models.

The term “instruction information” refers to content included in a prompt sentence that specifies how the generative AI model should generate output, including desired detail level, presentation format, and method of presenting a learning order.

The term “learning order” refers to a sequence or arrangement in which recommended learning materials or learning activities are suggested to be studied by a user to achieve effective learning.

The term “learning progress” refers to a state or degree of advancement of a user's learning over time, including aspects such as accumulated performance, completed materials, and current level of understanding.

The term “processor” refers to a hardware element, such as a central processing unit, that executes instructions of a data processing program to perform operations described in the system.

The term “server” refers to a computing system comprising at least one processor and at least one storage device, configured to perform data acquisition, storage, analysis, model processing, prompt generation, and communication with terminal devices.

In one embodiment, a server cooperates with at least one terminal and at least one user to implement the present invention. The server includes at least one processor, a main memory, a non-transitory storage device, and a communication interface. The terminal includes at least one processor, a display, an input interface such as a touch panel or keyboard, a memory, and a communication module. The user operates the terminal to input learning data and to consume learning materials recommended by the server.

The server executes an operating system such as a general-purpose server operating system on an electronic computing platform including a central processing unit (CPU) based on a common instruction set architecture. The server further executes application software written in a programming language such as Python. The server uses a data processing library such as a tabular data library (for example, Pandas), a numerical computation library, and a machine learning library such as a general-purpose machine learning toolkit (for example, scikit-learn). The server also uses a deep learning framework, such as a neural network framework, to interact with an external or internal generative AI model. The server stores learning data and learning material metadata in a relational database management system such as a structured query language (SQL) database.

The server stores a program in the non-transitory storage device. The processor of the server loads and executes the program in the main memory. The program causes the processor to function as multiple logical modules, including but not limited to: a data acquisition module, a storage management module, a statistical analysis module, a feature generation module, a machine learning inference module, a prompt generation module, a generative AI interaction module, and a user interface data generation module.

The server uses the data acquisition module and the communication interface to receive learning data from the terminal. The user operates the terminal to answer questions, complete tests, or input scores on an application or web page. The terminal converts the user's inputs into structured messages, which contain, for example, a user identifier, a learning session identifier, question identifiers, answer correctness flags, numeric scores, time stamps, and optionally topical labels. The terminal transmits these messages to the server via a network according to a communication protocol such as HTTPS. The server receives, validates, and stores the messages in the relational database. The storage management module assigns indexes, normalizes data formats, and writes the learning data to relational tables such as a user table, a test result table, and a question performance table.

The server uses the statistical analysis module to read learning data from the relational tables into an in-memory tabular data structure such as a data frame managed by the tabular data library. The server converts data types for each column in the data frame, for example, mapping categorical topic labels to string categories, mapping correctness flags to Boolean values, and mapping scores to numerical types. The server performs aggregation across columns and rows using group-based aggregation operations. For example, the server calculates, for each topic and difficulty level, an average score, a total number of attempts, a number of incorrect answers, an error rate, and a variance of scores. The server also performs time-based aggregations by grouping scores by date or period to obtain learning trends.

The server uses the feature generation module to transform analysis results into feature vectors suitable for input to the machine learning model. The server defines a feature schema that may include, for each topic or content category, numerical values representing error rate, average score, standard deviation, number of attempts, recency of last attempt, and trend data such as a slope of a regression line fitted to time-series scores. The server optionally performs dimensionality reduction or normalization, such as min-max scaling or standardization, across feature values to regulate input ranges for the model. The server encodes categorical attributes such as topic names or difficulty levels using techniques such as one-hot encoding or embedding indexing.

The server uses the machine learning inference module to estimate effectiveness values for a plurality of learning material candidates. In one embodiment, the server uses a tree-based ensemble model such as a random forest model. The server constructs the random forest model during an offline training phase, using historical learning data from many users and recorded outcomes such as post-material test scores or improvement measures. The server defines a loss function, such as mean squared error in predicted improvement, and adjusts model parameters, such as tree depth, number of estimators, and feature sampling ratios, to minimize the loss on validation data. The server stores the trained model parameters, including tree structures and node splitting criteria, as serialized data in the storage device.

In another embodiment, the server uses a gradient boosting model, a logistic regression model, or a multilayer perceptron model implemented in the machine learning library. The server represents each learning material candidate as a vector of features including content type, difficulty, estimated duration, and topical coverage. The server pairs these candidate features with the user-specific features generated from the learning history to form a combined feature vector. The server inputs the combined vector into the trained model. The model outputs one or more scores indicating expected effectiveness or suitability of each learning material candidate for the particular user.

The server uses the machine learning inference module to rank learning material candidates according to the predicted effectiveness scores. The server selects one or more top-ranked candidates as recommended learning materials. This selection process is not a simple rule-based mapping but a learned mapping from the high-dimensional feature space, allowing the system to capture complex interactions between user performance patterns and material characteristics. This contributes to improved prediction accuracy compared with human-crafted rules and reduces the need for manual tuning of recommendation rules.

The server uses the prompt generation module to convert the structured analysis results and the recommendation results into a natural language prompt sentence suitable for use by a generative AI model. The server constructs the prompt sentence by combining: (i) a concise description of the user's weaknesses inferred from error rates and score distributions; (ii) a list or summary of the recommended learning materials, including titles, content types, and difficulty levels; and (iii) explicit instructions specifying the desired style, length, and structure of the feedback. The server implements a deterministic template system and, optionally, conditional phrase selection rules to produce consistent prompts that guide the generative AI model toward predictable outputs.

For example, the server generates a prompt sentence such as:
“The user recently scored 40 out of 100 on present perfect and 50 out of 100 on passive voice, while scoring 90 out of 100 on simple present. The user often confuses present perfect with simple past. The system has selected the following learning materials: (1) ‘Mastering the Present Perfect’—interactive exercises for beginners and intermediate learners, and (2) ‘Understanding Passive Voice’—an intermediate-level video lecture. Based on these data, please recommend the best materials and explain in simple English why they are suitable. Please limit the explanation to three short paragraphs and use clear headings.”

In another example, the server generates a prompt sentence such as:
“The user has a high error rate in questions related to present perfect, especially when deciding between present perfect and simple past. The user has 30 minutes per day for study. Please design a one-week study plan using short grammar exercises and one video material per day, focusing on present perfect. Output the plan as a day-by-day list in English with concise bullet points.”

The server uses the generative AI interaction module to communicate with a generative AI model that implements, for example, a transformer-based neural network. In one embodiment, the generative AI model contains multiple attention layers, each with multiple attention heads, feed-forward layers, and layer normalization. The generative AI model is pre-trained on large-scale text corpora and optionally fine-tuned on instructional or educational text. The generative AI model uses token embeddings, positional encodings, and attention weights to process the prompt sentence and generate a sequence of tokens as output text. The server specifies decoding parameters such as maximum token length, temperature, and presence penalties to control the variability and conciseness of the generated feedback.

The server transmits the prompt sentence as a text string to the generative AI model via an application programming interface. The server receives the generated token sequence representing feedback information. The server may apply post-processing such as trimming extremely long outputs, enforcing paragraph breaks, and filtering out irrelevant segments based on predefined keywords or patterns. The server converts the resulting text into user interface data, combining it with metadata for the recommended learning materials, such as titles and access links.

The terminal receives the user interface data from the server. The terminal parses the data and renders a graphical user interface that presents the recommended learning materials along with the generated feedback information. The user views the recommended materials and reads the explanations, study plan, or guidance. The user selects and activates one of the recommended materials by touching or clicking a displayed element. The terminal then opens a content viewer, such as a web browser, a document viewer, or a multimedia player, to present the learning material to the user.

This configuration provides multiple technical effects at the level of computer technology. The server uses the tabular data structure and feature generation schema to reduce redundant data scanning and to enable vectorized operations in the tabular data library. As a result, the server reduces CPU usage and accelerates statistical analysis compared with naive per-record processing. The explicit error rate and trend computation enable the system to focus the generative and predictive models on the most informative features, thereby improving model convergence during training and reducing inference latency during operation.

The integration of the machine learning model and the generative AI model in a structured pipeline provides further technical improvements. By using the machine learning model to pre-select a narrowed set of learning material candidates, the server reduces the amount of context that must be encoded into each prompt sentence and processed by the generative AI model. This reduction in prompt size and candidate space decreases communication payload size and shortens response time from the generative AI model. Thus, the system lowers network load and reduces computational burden on the generative AI model while maintaining or improving personalization quality.

The server's prompt generation module defines explicit, machine-controlled rules for constructing prompt sentences. Unlike a human operator who might provide free-form instructions to a generative model, the server uses structured templates and deterministic field insertion based on the analysis results. This approach transforms loosely coupled AI components into a tightly integrated computing system in which the generative model acts as a controllable subcomponent. By constraining the generative model through consistent prompt design, the server achieves more stable and reproducible behavior, which is a significant improvement in the technical field of AI-assisted content generation.

The server also improves data management by maintaining the learning data in normalized relational tables and in in-memory tabular structures optimized for statistical operations. The specific choice of features (error rates per topic, score distributions, trend slopes, and recency metrics) enables the server to compress the history of many sessions into compact numerical vectors that are still highly informative for the machine learning model. This yields efficient memory usage and accelerates model inference. The server thus scales to a large number of users and materials without requiring linear growth in computational resources.

The machine learning model and generative AI model do not merely automate human tasks but apply non-human, algorithmic rules and optimization procedures. The machine learning model is trained using gradient-based optimization over large datasets to minimize a well-defined loss function. During training, the server repeatedly computes prediction errors between model outputs and actual observed improvements, and uses an optimization algorithm such as stochastic gradient descent or a variant thereof to update model parameters. The generative AI model uses multi-layer neural network architectures with learned weight matrices and attention mechanisms that are not representable as simple human-authored rule sets. These models discover structures and patterns in data that a human might not identify, enabling higher accuracy in predicting effective materials and generating coherent explanations tailored to complex user performance patterns.

The server may implement alternative embodiments. In one embodiment, the machine learning model is a neural network with multiple hidden layers, where each layer applies an activation function such as a rectified linear unit to a linear transformation of the input. The server trains this neural network using a supervised learning method with backpropagation and a loss function such as cross-entropy when predicting probability distributions over candidate materials. In another embodiment, the server uses a sequence model that considers temporal order of learning sessions and directly models how the user's performance evolves over time.

In another embodiment, the server fine-tunes the generative AI model using domain-specific corpora, such as collections of high-quality grammar explanations and study plans. The server uses a training objective that minimizes the divergence between generated text and human-authored reference explanations. The server may apply data augmentation methods, such as paraphrasing and topic masking, to expand training data and improve generalization. The resulting fine-tuned model outputs explanations that are more concise and pedagogically reliable than generic language models, contributing to a direct technical improvement in the quality of generated text per unit of computational cost.

In yet another embodiment, the server applies caching strategies to store frequently used intermediate results, such as user feature vectors and ranked material lists. When the user sends new learning data that only slightly modifies the previous statistics, the server updates the cached features incrementally rather than recomputing from scratch. This incremental update scheme reduces processor load and shortens end-to-end response times. The server may also cache generative AI outputs for typical weakness patterns, further reducing calls to the generative AI model when similar user profiles reoccur.

In a further embodiment, the server operates in a distributed configuration, where different modules run on different physical nodes. For example, a front-end node may manage data acquisition and user interface data generation, while a back-end node manages statistical analysis and machine learning inference, and another node interacts with the generative AI model. The distributed configuration allows horizontal scaling and enhances fault tolerance. Efficient serialization of the tabular data structures and feature vectors between nodes reduces network traffic and supports low-latency operation.

By combining these elements, the server, the terminal, and the user cooperate to realize a technically improved learning support environment. The system enhances processing speed by using vectorized statistical computations and incremental updates, improves accuracy of recommendations through learned models based on rich feature representations, reduces communication load by narrowing the set of candidate materials before generative processing, and stabilizes generative output quality through controlled prompt sentence construction. These technical effects arise from the particular arrangement and interaction of software modules, data structures, and trained models within the computer system, and not merely from abstract ideas or human mental processes.

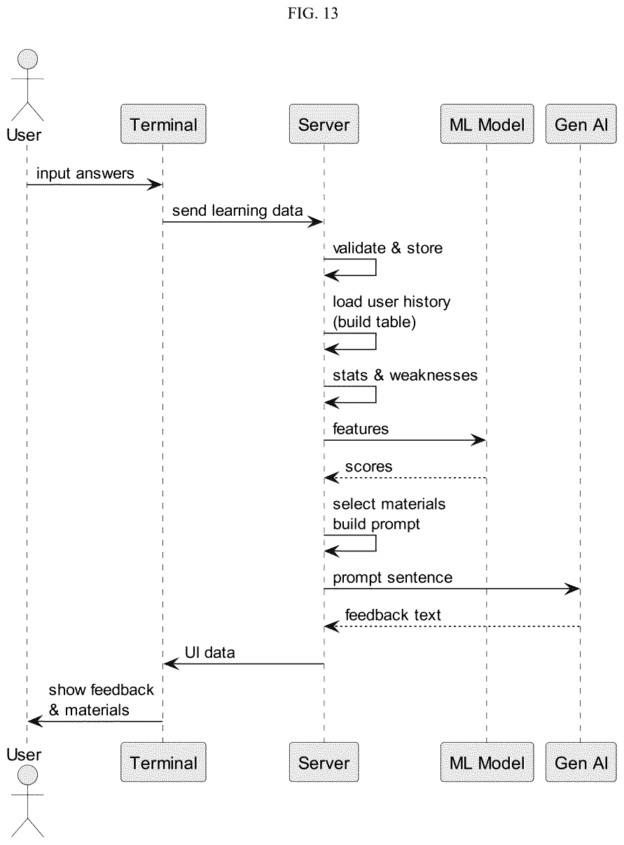

The following describes the processing flow using FIG. 13.

### Step 1

The user operates the terminal to perform learning activities and input results. The user answers questions, selects options, and confirms scores on a test screen. The terminal receives raw interaction data as input, including selected choices, response times, and completion status. The terminal converts this raw interaction data into structured learning data by assigning identifiers (user ID, session ID, question ID), adding timestamps, and computing basic fields such as per-question correctness flags and per-test total scores. The terminal outputs a structured message, for example a key-value set, representing the learning data.

### Step 2

The terminal transmits the structured learning data to the server. The terminal uses a communication module to send the message via a network protocol such as HTTPS to a predefined server endpoint. The input of this step is the structured learning data generated in Step 1. The terminal packs the data into a request payload and attaches authentication tokens if necessary. The terminal outputs a network request that encapsulates the learning data and sends it to the server.

### Step 3

The server receives and validates the learning data. The server uses a communication interface to accept the network request as input. The server parses the payload to extract fields such as user ID, test ID, question IDs, correctness flags, and scores. The server checks data types, mandatory fields, and value ranges to detect malformed records. Based on this validation, the server either accepts the data or discards or corrects invalid entries according to predefined rules. The server outputs validated learning data records suitable for storage.

### Step 4

The server stores the validated learning data in a relational database. The server uses a storage management module and a database driver to receive the validated records as input. The server maps each record to relational tables, such as a user table, a test result table, and a question performance table. The server transforms the input fields into table columns, generates primary keys if needed, and executes insert or update operations. The server commits the database transaction to ensure persistence. The server outputs stored data entries, now indexed and available for later retrieval.

### Step 5

The server retrieves accumulated learning data for a target user and constructs a tabular data structure. The server uses the user identifier as input to query the relational database. The server executes select queries to collect multiple records from previous sessions, including question-level results, topic labels, difficulty levels, and timestamps. The server loads the query results into memory and uses a data processing library to assemble them into a data frame with columns such as topic, difficulty, is_correct, score, and test_date. The server outputs a tabular data structure representing the user's learning history.

### Step 6

The server performs statistical analysis of the tabular learning data. The server uses the data frame from Step 5 as input. The server groups rows by topic and difficulty, and applies aggregation functions to compute metrics such as total attempts, number of correct answers, number of incorrect answers, error rate (incorrect/attempts), average score, and score variance. The server also aggregates scores by time period to compute learning trends, for example by computing weekly average scores and fitting a simple linear regression to derive a trend slope. The server outputs an analysis result that includes, for each topic and difficulty, the computed metrics and trend information.

### Step 7

The server identifies candidate weaknesses based on the analysis result. The server uses topic-wise metrics from Step 6 as input. The server compares error rates and average scores for each topic against predetermined thresholds, such as error rate greater than a given limit or average score below a target value. The server filters topics that meet these criteria and sorts them in order of severity, for example by descending error rate or by a combination of error rate and low improvement trend. The server registers these topics and associated metrics as candidate weaknesses. The server outputs structured data describing the weaknesses, including topic names, error rates, average scores, and trend slopes.

### Step 8

The server generates feature data for input to a machine learning model. The server uses the candidate weaknesses, the analysis result, and the user's broader learning history as input. The server encodes each topic's statistics into numerical features, such as normalized error rates, z-scored averages, recency scores, and difficulty indicators. The server also encodes material-related attributes, such as topic coverage and difficulty of candidate materials, into numerical or categorical features. The server concatenates user features and material features to form a feature vector for each learning material candidate. The server outputs a set of feature vectors corresponding to the candidate materials.

### Step 9

The server estimates the effectiveness of learning material candidates using a machine learning model. The server uses the feature vectors from Step 8 as input. The server loads a pre-trained model, such as a random forest model, a gradient boosting model, or a neural network, from a serialized representation. The server feeds each feature vector into the model, which applies internal computations such as decision tree traversals or matrix multiplications and activation functions. The model produces an effectiveness score or probability for each material candidate. The server collects these scores into a ranked list. The server outputs an estimation result containing each material candidate and its predicted effectiveness.

### Step 10

The server selects recommended learning materials based on the estimation result. The server uses the list of candidates and associated effectiveness scores from Step 9 as input. The server sorts the candidates by score in descending order and applies selection rules, such as choosing the top N items or applying constraints on difficulty balance and topic coverage. The server may also apply diversity rules to avoid recommending multiple highly similar materials. The server generates a final set of recommended learning materials, each with associated metadata such as title, type, difficulty, and access link. The server outputs this set as a recommendation list for the user.

### Step 11

The server constructs a prompt sentence for a generative AI model. The server uses the candidate weaknesses from Step 7 and the recommended materials from Step 10 as input. The server selects key information, such as specific topics with high error rates and the names and types of recommended materials. The server inserts this information into a predetermined textual template that also includes instructions for the response format, length, and tone. The server concatenates these elements into a single coherent natural language string. The server outputs a prompt sentence ready to be provided to the generative AI model.

### Step 12

The server sends the prompt sentence to the generative AI model and obtains generated feedback. The server uses the prompt sentence from Step 11 as input. The server transmits the prompt text to an external or internal generative AI engine via an application programming interface. The generative AI engine processes the prompt using a transformer-based neural network and returns a generated text sequence. The server receives this sequence, which contains explanations, recommendations, and possibly a study plan. The server may process the text to enforce constraints, such as trimming excess length or normalizing formatting. The server outputs refined feedback information in text form.

### Step 13

The server combines the generated feedback with material metadata and prepares user interface data. The server uses, as input, the feedback text from Step 12 and the recommended material list from Step 10. The server formats the feedback into paragraphs, headings, or bullet points and associates each recommended material with an explanation or justification. The server structures this information into a presentation format suitable for the terminal, such as a list of items with associated text fields and links. The server generates a response payload that contains all necessary display elements. The server outputs user interface data containing feedback and recommendation details.

### Step 14

The server transmits the user interface data to the terminal. The server uses the structured user interface data from Step 13 as input. The server encapsulates the data in a response message using a communication protocol such as HTTPS. The server sets appropriate headers and sends the message to the terminal's network address. The server outputs a network response carrying the user interface data.

### Step 15

The terminal receives the user interface data and renders a recommendation screen. The terminal uses the network response from Step 14 as input. The terminal parses the payload, extracts the feedback text, the list of recommended materials, and the corresponding links or identifiers. The terminal constructs graphical elements such as text areas, buttons, and list items, and arranges them on the display. The terminal associates user actions, such as taps or clicks, with navigation to the corresponding material links. The terminal outputs a displayed screen that presents the recommendations and feedback in a form accessible to the user.

### Step 16

The user reviews the recommendations and starts a learning session. The user uses the displayed screen from Step 15 as input for decision-making. The user reads the generated feedback, identifies weaknesses and suggestions, and selects one of the learning materials shown on the terminal. The user performs an action such as tapping a material item, which the terminal detects as an input event. The user's selection becomes the basis for the next learning activity. The user's subsequent interactions with the chosen material will generate new learning data, which the terminal will again structure and transmit, thereby repeating and refining the entire processing flow.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented language learning systems generally treat feedback generation and content recommendation as static operations driven by fixed rules or simple statistical thresholds. In such systems, a processing unit typically analyzes user answers with hand-crafted logic and then retrieves pre-defined materials using simple matching against a user level. As a result, the underlying computation is limited to rigid evaluation and lookup processes that do not flexibly adapt to complex combinations of user weaknesses, long-term learning history, and real-time emotional state. This causes several technical problems in the processing performed by the computer system.

First, the processor in conventional systems lacks a unified mechanism to translate rich, multi-dimensional user state information into machine-interpretable instructions for a generative model. Even when a generative model is available as a back-end service, the front-end application logic usually sends generic requests that do not reflect detailed user metrics. Consequently, the computing resources are not utilized efficiently: the model output is under-constrained, noisy, and often requires substantial post-processing, which increases CPU load, memory usage, and network traffic between components.

Second, existing systems generally do not maintain an integrated, machine-readable representation of the user's evolving ability profile and emotional state that can be fed back into a generative model in a closed loop. Learning logs, test scores, and any emotion-related signals are typically stored in separate data structures or services and are processed independently. Because these disparate data streams are not fused into a coherent control signal for content generation, the processor cannot dynamically adjust difficulty level, content amount, or presentation order in response to subtle changes in learning behavior or emotional state. This results in inefficient data flows and sub-optimal scheduling decisions within the computer system, such as unnecessary repetitions or inappropriate jumps in difficulty.

Third, conventional feedback mechanisms often rely on task-specific code paths for grammar checking, vocabulary evaluation, and pronunciation assessment. Each of these paths may call different modules or external services, and the orchestration logic is duplicated or fragmented. This architecture leads to complex control flows, increased latency, and higher maintenance overhead, because any change in feedback policy requires modification of multiple code modules. Additionally, the absence of a prompt-driven orchestration layer means that the generative model cannot be used as a generic reasoning engine to synthesize corrections, explanations, and next-step recommendations from heterogeneous input data.

Fourth, known systems typically do not implement an iterative prompt-construction mechanism that explicitly encodes learning-progress information and emotion-state information into the instructions for a generative model. Without such an iterative mechanism, the processor cannot refine the prompts based on prior outputs and newly acquired interaction data, and therefore cannot continuously optimize the internal decision logic about which content to generate or how to structure feedback. This limitation prevents the system from converging toward stable, personalized behavior and causes redundant computation in both the application server and the generative model service.

Accordingly, there is a need for a computer-implemented technique that improves the way a processor in a learning support system acquires and aggregates learning-related information and emotion-related information, transforms that information into structured prompt sentences suitable for a generative AI model, receives and interprets model outputs, and iteratively updates content selection and feedback generation. By re-architecting the interaction between the application logic and the generative model as a closed, prompt-driven control loop, the invention seeks to improve the efficiency, adaptability, and scalability of the underlying computer system itself, rather than merely automating a human teaching process.

The specific processing by the specific processing unit 290 of the data processing device 12 in Application Example 2 is realized by the following means.

The present invention provides a server comprising a processor configured to acquire learning-related information and emotion-related information of a user from at least one input device, a user interface, and a storage device; to generate, by executing analysis logic using computational resources, ability-evaluation information and weakness-region information of the user from the learning-related information and the emotion-related information; to construct a structured prompt sentence for a generative AI model based on the ability-evaluation information and the weakness-region information, the prompt sentence including explicit instructions for analysis and content generation; to input the prompt sentence together with at least a portion of the learning-related information into the generative AI model and to cause the generative AI model to execute an analysis process and a content-generation process; to identify, from an output of the generative AI model, at least one weakness region in language ability of the user and to extract or generate corresponding learning-content information and feedback information; to dynamically adjust at least one of a difficulty level, an amount, and a presentation order of the learning-content information based on the emotion-related information; and to present the adjusted learning-content information and the feedback information to the user via the user interface while continuously updating the learning-related information and iteratively modifying subsequent prompt sentences and learning-content information in accordance with newly acquired interaction data. This enables the computer system to operate as a closed, prompt-driven control loop that more efficiently utilizes generative model resources, reduces redundant processing across separate analysis modules, and dynamically optimizes content generation, feedback generation, and scheduling decisions in response to detailed learning-progress information and emotion-state information, thereby improving the technical performance and adaptability of the underlying information processing infrastructure.

The term “learning-related information” refers to data that represents a user's behavior and performance in a learning activity, including but not limited to language data, answers, scores, response times, and operation history on learning content.

The term “emotion-related information” refers to data that represents or is used to infer a user's emotional state during a learning activity, including but not limited to sensor outputs such as image data, audio data, and explicit user-reported feelings.

The term “ability-evaluation information” refers to data that expresses an estimated level or profile of a user's abilities in one or more skill domains, such as language comprehension, production, or vocabulary knowledge, derived from analysis of learning-related information and emotion-related information.

The term “weakness-region information” refers to data that specifies one or more aspects or sub-skills within a broader ability domain in which a user exhibits relatively low performance or frequent errors, identified through analysis of ability-evaluation information and learning-related information.

The term “generative AI model” refers to a computational model implemented by software and hardware resources that is trained to produce output data, such as text, structured data, or other content, in response to input data and instructions, and that is capable of performing analysis and content generation tasks based on probabilistic or learned representations.

The term “prompt sentence” refers to a machine-readable instruction sequence, represented as text or structured data, that is provided as input to a generative AI model in order to specify a task, constraints, and desired output format for analysis or content generation.

The term “analysis process” refers to a sequence of computational operations performed by a processor or a generative AI model to interpret, classify, score, or otherwise evaluate input data, such as learning-related information and emotion-related information.

The term “content-generation process” refers to a sequence of computational operations performed by a processor or a generative AI model to create new learning content, feedback messages, examples, or other instructional materials from input data and prompt sentences.

The term “learning-content information” refers to data that defines or describes one or more units of instructional material, including but not limited to texts, questions, examples, exercises, explanations, and associated metadata such as topic and difficulty level.

The term “feedback information” refers to data that provides evaluative or advisory information to a user regarding the user's performance or behavior, including but not limited to error indications, corrected examples, explanations, hints, and learning guidance.

The term “difficulty level” refers to a parameter or label associated with learning-content information that indicates a relative complexity or challenge of the content for a user, determined based on ability-evaluation information and other performance indicators.

The term “presentation order” refers to a sequence or arrangement in which multiple pieces of learning-content information or feedback information are provided to a user via a user interface.

The term “user interface” refers to a hardware and software combination that enables interaction between a user and the system, including but not limited to display devices, input devices, and graphical or auditory presentation components.

The term “sensing device” refers to any hardware component configured to obtain physical signals related to a user, including but not limited to cameras, microphones, and physiological sensors, for use in generating emotion-related information.

The term “storage device” refers to one or more hardware components or subsystems configured to store data, including but not limited to non-volatile memories, magnetic storage media, and solid-state storage units, used for retaining learning-related information, emotion-related information, and generated content.

The term “learning operation history” refers to a subset of learning-related information that records chronological user interactions with the system, including selections, inputs, responses, navigation actions, and time stamps during learning sessions.

The term “learning-progress information” refers to data that characterizes temporal changes in a user's performance and behavior over multiple learning sessions, including learning history, performance transitions, response-time trends, and emotion-state estimations.

The term “emotion state” refers to an inferred or declared psychological condition of a user, such as stress, boredom, motivation, or satisfaction, represented in a machine-interpretable form within the system.

The term “computational resources” refers to processing units, memory units, and communication paths within an information processing apparatus that are used to execute analysis processes, content-generation processes, and other control logic.

The term “information processing apparatus” refers to a hardware and software platform that includes at least one processor, at least one memory, and at least one communication interface, configured to execute programs for analysis, content generation, and control in the system.

In one embodiment, a server, a terminal, and a communication network together implement the claimed system. The server includes at least one processor, a main memory, a non-volatile storage device, and a network interface. The terminal includes at least one processor, a display device, at least one input device such as a touch panel or keyboard, at least one sensing device such as a camera and a microphone, and a communication interface. The server and the terminal communicate through a wired or wireless network.

The server executes an operating system such as a general-purpose server operating system and middleware such as a web server framework and an application framework. The server further executes a data processing program that implements functions of acquiring learning-related information and emotion-related information, generating ability-evaluation information and weakness-region information, constructing and transmitting prompt sentences to a generative AI model, receiving and interpreting output from the generative AI model, dynamically adjusting learning-content information, and presenting learning-content information and feedback information to the user via the terminal. The terminal executes an application program, for example a cross-platform mobile application framework, that acquires user inputs, displays learning-content information and feedback information, and acquires sensor data as emotion-related information.

The server stores learning-related information, emotion-related information, ability-evaluation information, weakness-region information, learning-content information, and feedback information in at least one storage device such as a relational database system. The server organizes these data into specific data structures. For example, the server stores, for each user, a learning log table including fields such as user identifier, content identifier, timestamp, response value, correctness flag, and response time. The server also stores, for each user, an ability profile table including fields such as a grammar score, a listening score, a speaking score, a vocabulary score, and uncertainty parameters. The server further stores, for each user, an emotion state table including fields such as timestamp, emotion class, and confidence values. These specific data structures enable the processor to efficiently retrieve and aggregate information across multiple learning sessions and to generate compact feature vectors for analysis.

The server uses software libraries such as numerical computation libraries and machine learning frameworks to perform analysis. For example, the server uses a numerical computation library to compute statistics such as average score per skill, error rates per item type, and moving averages of response time. The server uses a machine learning framework such as a tensor computation library to implement a neural network model that transforms the aggregated statistics and contextual features into ability-evaluation information and weakness-region information. In one embodiment, the server uses a feed-forward neural network with multiple layers. The input layer receives a feature vector constructed from learning-related information, including, for example, normalized scores, counts of errors by error type, counts of content items per topic, and time intervals between sessions. Hidden layers include fully connected layers with nonlinear activation functions. The output layer produces continuous values corresponding to predicted ability scores for each skill domain and discrete values corresponding to weakness flags.

The server trains the neural network model offline. The server acquires training data consisting of historical learning-related information and associated ground-truth labels of ability and weaknesses. The server defines a loss function such as a weighted sum of mean squared error between predicted scores and target scores and cross-entropy loss for weakness flags. The server updates network weights by applying an optimization algorithm such as stochastic gradient descent or a variant. The server may perform data augmentation by perturbing numerical features within allowed ranges to improve robustness. The server stores trained model parameters in the storage device and loads them into memory at runtime.

The server additionally uses a generative AI model, which is a language model implemented on a separate computation resource or service, to generate or refine learning-content information and feedback information. In one embodiment, the generative AI model is a transformer-based neural network that receives textual input and produces textual output. The server does not treat the generative AI model as a black box. Instead, the server explicitly constructs a prompt sentence that encodes both user-specific state and system-specific constraints in a structured manner. The processor applies specific prompt-construction rules that map internal data structures to textual instructions, thereby reducing ambiguity in the generative AI model's task and improving determinism of the output.

The server generates prompt sentences by combining three classes of information: user state information, task instruction, and output format specification. The user state information portion may include summaries such as levels in grammar, listening, speaking, and vocabulary, as well as an indication of the current emotion state and recent performance trends. The task instruction portion may specify whether the generative AI model is requested to analyze an error, generate new exercises, or recommend the next skill to practice. The output format specification portion may constrain the length, difficulty level, and structure of the generated content.

In one example, when the server desires the generative AI model to propose new listening exercises, the processor constructs a prompt sentence such as:
“The learner has the following profile:
Grammar: medium overall, weak in third-person singular and past tense.
Listening: low, especially for airport and restaurant dialogues.
Speaking: low confidence, many pauses.
Vocabulary: medium, around B1 level.
Emotion: current state is ‘stress’.

Please propose 5 short, easy listening exercises focusing on airport and restaurant dialogues.

Each exercise should include: (1) a short script, (2) 3 comprehension questions, and (3) a simple encouragement message.”

In another example, when the server requests detailed feedback on a particular sentence, the processor constructs a prompt sentence such as:
“Analyze the following learner sentence:
‘He go to school every day.’

### Tasks

1. Identify all grammatical errors.
2. Provide the corrected sentence.
3. Explain the corrections in simple English suitable for an A2 learner.”
In another example, when the server determines that the user's vocabulary performance has reached a threshold, the processor constructs a prompt sentence such as:
“The learner has completed 80% of the current intermediate vocabulary set with an average score of 85%.
Please propose the next vocabulary set at upper-intermediate (B2) level, focusing on business English.
Include 20 words with example sentences.”

The server transmits such prompt sentences, together with necessary user-state data, to the generative AI model through an application programming interface. The server reduces network traffic and latency by pre-aggregating learning-related information into compact summaries before inclusion in the prompt sentence, thereby avoiding repeated transmission of raw event logs. Additionally, the server caches frequent prompt patterns and reuses them, modifying only the user-specific fields as needed. This reduces computational overhead of prompt generation and facilitates stable behavior of the generative AI model.

The terminal plays a crucial role in acquiring both learning-related information and emotion-related information. The terminal displays learning-content information and feedback information received from the server and monitors user interactions. For example, the terminal records taps, text inputs, answer selections, and timestamps. The terminal records that the user has listened to an audio item and how many times the user has replayed the audio. The terminal transmits these information items in a structured format to the server. The terminal also acquires image data from a camera and audio data from a microphone while the user interacts with the system, provided that permissions are granted. The terminal may preprocess the sensor data to extract features such as facial landmarks and prosodic features and transmit such features to the server as emotion-related information.

The server uses a separate emotion-analysis module to map the emotion-related information to an emotion state. In one embodiment, the server uses a neural network classifier that takes as input vectors of image features and acoustic features and outputs probabilities for emotion classes such as stress, boredom, neutral, and engagement. The server trains this classifier with labeled examples of user expressions and voice patterns. The server stores emotion state information in the emotion state table and associates it with timestamps and content identifiers. The ability-evaluation model uses the emotion state as an additional input feature. Thus, the processor can distinguish, for example, between low performance due to lack of skill and low performance due to high stress.

The server does not simply rely on human-defined rules for content selection. Instead, the server uses a specific algorithm that integrates ability-evaluation information, weakness-region information, learning-progress information, and emotion-state information to compute a priority score for each candidate piece of learning-content information. The server may use a multi-objective scoring function that assigns weights to factors such as expected learning gain, emotional suitability, and review spacing. The server can implement the scoring function using a linear model or a small neural network. This scoring mechanism is not merely an automation of a teacher's choices; rather, it is an algorithmic optimization that operates over high-dimensional feature vectors and optimizes for system-level criteria such as minimizing expected error rate and balancing load on the generative AI model.

The interaction between the server and the generative AI model follows a non-conventional, prompt-driven orchestration pattern. Instead of invoking separate, specialized services for grammar checking, vocabulary selection, and content recommendation, the server uses the generative AI model as a unified reasoning engine controlled by a structured prompt sentence. This reduces fragmentation of code paths and allows the processor to route diverse tasks through a single interface. The server explicitly interprets the output of the generative AI model by matching output patterns against predefined schemas. For example, when requesting exercises, the prompt sentence instructs the generative AI model to return a numbered list of exercises with specific fields. The server validates the output and discards or corrects content that does not match the expected schema. This combination of strict prompt design and schema-based validation yields technical effects such as reduced error rate in generated content, reduced need for post-hoc manual curation, and improved predictability of system operation.

The system improves computer technology in several ways. First, by centralizing decision logic into a prompt-driven control loop, the server reduces redundant computation in separate modules and lowers total processing time. The server avoids repeated parsing and reformatting of data for different services and instead uses a consistent internal representation for user state and tasks. Second, by fusing learning-related information and emotion-related information into unified feature vectors, the server enables more accurate ability evaluation and content selection, which in turn reduces unnecessary network calls and decreases latency. When the processor can more accurately predict the type of content that will be effective, it can request fewer, more targeted generations from the generative AI model, thereby reducing network bandwidth and computational resource usage.

Third, the system improves data management by storing data in normalized tables keyed by user and time, and by maintaining derived tables for aggregates invoked by the evaluation and recommendation components. Because the ability-evaluation model and the content-selection algorithm operate on these derived tables rather than raw logs, the server can answer queries with fewer disk reads and cache more data in memory. This results in faster response times and improved scalability. Fourth, by designing the generative AI model interactions as a sequence of well-structured prompt sentences, the server reduces ambiguity and reinforces determinism in the generative AI model's behavior. This reduces variance in output quality and simplifies downstream processing, which are technical improvements over naive generation workflows.

In use, the user operates the terminal to read texts, listen to audio, and answer questions. The user may also type free-form sentences or speak into the microphone to practice writing and speaking. The terminal sends these inputs as learning-related information to the server. When the user inputs a sentence such as “He go to school every day.”, the server first detects a possible subject-verb agreement problem through simple natural language processing. The server then constructs a prompt sentence instructing the generative AI model to identify and explain grammatical errors. The generative AI model responds with a corrected version and an explanation. The server structures this information as feedback information, and the terminal displays it to the user with appropriate highlighting. The system thus performs analysis and feedback generation in a manner that is technically distinct from manual correction, because the analysis and generation are driven by a trained neural network and machine-readable prompt sentences integrated with system-level data structures.

In another specific example, when the system determines that the user is weak in listening, the server constructs a prompt sentence such as:
“Based on the user's learning history, please propose the next learning materials. The user's main weakness is listening.”

The generative AI model then returns a set of suggested material descriptions. The server converts these descriptions into structured learning-content information, possibly by mapping them to pre-existing audio files or by requesting additional text-to-speech synthesis. The server records which items were generated and associates them with difficulty levels and topic tags. The terminal presents these materials, records user interactions, and sends new learning-related information back to the server. The closed loop thereby continues.

Alternative embodiments are possible. The server may implement the generative AI model locally instead of calling a remote service. In such a case, the server stores model parameters in the storage device and loads them into memory. The server then executes forward passes of the transformer layers or other neural network layers to generate outputs in response to prompt sentences. The prompt construction, feature extraction, and content-selection logic remain similar. Alternatively, the server may use different architectures for ability evaluation, such as recurrent neural networks or gradient-boosted decision trees. The scoring function for content selection may be implemented as a reinforcement learning policy that uses predicted learning gains as rewards.

The terminal may be implemented as a smartphone, a tablet, a personal computer, or a head-mounted display device. The sensing devices may include not only cameras and microphones but also additional sensors such as accelerometers and heart-rate monitors. The server may use these sensor data as additional features in the emotion-analysis module. The user interface may vary in layout and interaction style, but the essential functions of displaying learning-content information and feedback information and capturing inputs remain. The communication between the server and the terminal may use different network protocols, but the system maintains the logical flow of acquiring learning-related information and emotion-related information, generating ability-evaluation information and weakness-region information, constructing and applying prompt sentences for a generative AI model, and iteratively updating content and feedback.

Through these structural elements and processing flows, the system as described implements the claimed features in a way that yields concrete technical effects in the operation of the computer system. The server coordinates structured data storage, neural network-based evaluation, prompt-driven generative content, and emotion-aware adjustment of learning-content information to provide not only personalized instruction but also improved processing efficiency, improved accuracy of evaluation, reduced communication load, and reduced redundancy in code and computation.

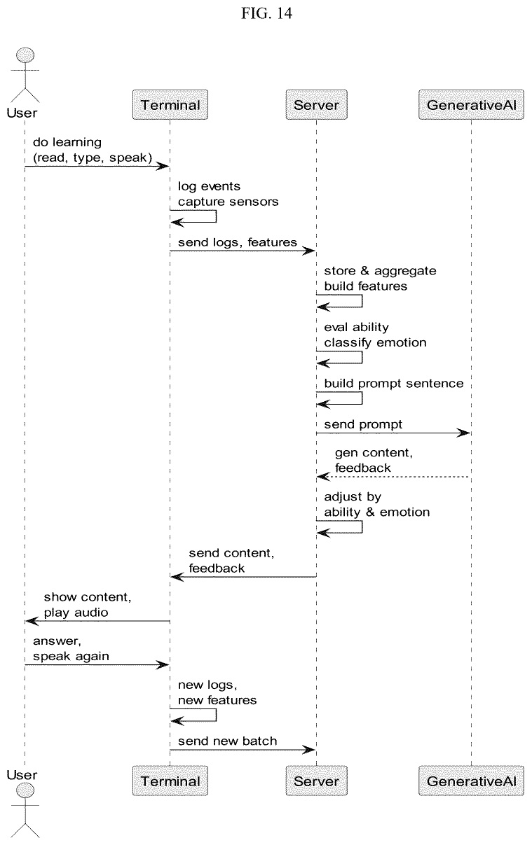

The following describes the processing flow using FIG. 14.

### Step 1

User operates the terminal to perform learning activities and provide language input.

User reads learning content on the display, listens to audio, selects answers, types sentences, and speaks into the microphone. The input of Step 1 is raw user interaction, including tap events, typed text, and spoken utterances. The output of Step 1 is event data, text data, and audio data captured by the terminal.

### Step 2

Terminal records learning-related information and emotion-related information.

Terminal converts user interactions from Step 1 into structured logs that include content identifiers, timestamps, selected options, correctness flags (when available), and response times. Terminal simultaneously captures image frames from a camera and audio segments from a microphone as emotion-related information, or extracts features such as facial landmarks and prosodic features. The input of Step 2 is the event data, text data, and audio data from Step 1. The output of Step 2 is a set of structured learning-related records and emotion-related feature vectors to be transmitted to the server.

### Step 3

Terminal transmits structured data to the server.

Terminal packages the learning-related records and the emotion-related feature vectors into a formatted request, and sends this request to the server via a network interface using a communication protocol. Terminal may batch multiple events into a single payload to reduce communication overhead. The input of Step 3 is the structured logs and feature vectors produced in Step 2. The output of Step 3 is a network message containing these logs and features that arrives at the server.

### Step 4

Server stores and normalizes incoming user data.

Server receives the network message from the terminal and parses the payload into internal data structures. Server validates the schema, discards malformed entries, and writes valid learning-related information into a learning log table, and emotion-related information into an emotion state table within a storage device. Server may normalize units and encodings, such as converting timestamps to a standard time zone or mapping content identifiers to canonical forms. The input of Step 4 is the network message from Step 3. The output of Step 4 is persisted, normalized records in the learning log table and the emotion state table.

### Step 5

Server aggregates learning-related information into feature vectors.

Server executes a data-processing routine that reads recent records from the learning log table for a given user and computes aggregated statistics such as average correctness per skill, error rates per item type, average response time, and recent trend indicators. Server organizes these statistics into a fixed-length numerical feature vector. The input of Step 5 is a set of normalized learning-related records for the user retrieved from storage. The output of Step 5 is a numerical feature vector representing the user's recent learning performance.

Step 6:

Server evaluates user ability and weakness regions using a dedicated neural network.

Server feeds the feature vector from Step 5 into an ability-evaluation neural network implemented in a machine learning framework. Server performs matrix multiplications and nonlinear activations in a feed-forward manner to obtain predicted ability scores for each skill domain and probability values for candidate weakness regions. Server then thresholds or ranks these outputs to generate ability-evaluation information and weakness-region information. The input of Step 6 is the feature vector from Step 5. The output of Step 6 is a set of ability-evaluation values and weakness-region flags stored as structured records.

### Step 7

Server computes an emotion state from emotion-related information.

Server retrieves recent emotion-related feature vectors from the emotion state table and inputs them into an emotion-classification module, which may be a neural network classifier or a statistical model. Server processes the feature vectors to generate probabilities for emotion classes such as stress, boredom, or engagement and selects the class with maximum probability as the current emotion state. Server attaches a confidence score to the emotion state and stores this result. The input of Step 7 is a collection of emotion-related feature vectors from Step 4. The output of Step 7 is a discrete emotion state label and associated confidence value for the user.

### Step 8

Server compiles a user state summary for use in prompt construction.

Server combines results from Step 6 and Step 7 with additional history such as cumulative progress and recent topics. Server formats this information into a compact textual or structured summary describing strengths, weaknesses, and emotion state. The input of Step 8 is the ability-evaluation information, weakness-region information, emotion state, and historical metadata. The output of Step 8 is a user state summary ready to be embedded into a prompt sentence for a generative AI model.

### Step 9

Server determines a task type and constructs a prompt sentence.

Server selects a task type, such as “generate new exercises,” “provide detailed feedback,” or “recommend next vocabulary set,” based on the user state summary from Step 8 and system policies. Server applies prompt-construction rules that map the task type and user state summary into a natural-language instruction string. For example, server may create a prompt sentence such as:
“The learner has the following profile: Please propose 5 short, easy listening exercises focusing on airport and restaurant dialogues.”

The input of Step 9 is the user state summary and the selected task type. The output of Step 9 is a task-specific prompt sentence to be sent to the generative AI model.

### Step 10

Server sends the prompt sentence and context to the generative AI model.

Server packages the prompt sentence together with any additional context, such as specific learner sentences or targeted topics, into a request message and transmits this message to a generative AI model endpoint via a network interface. Server may include constraints such as maximum response length or required output structure in the request parameters. The input of Step 10 is the prompt sentence and contextual data from Step 9. The output of Step 10 is a remote inference request received and processed by the generative AI model.

### Step 11

Server receives and parses the output of the generative AI model.

Server obtains the textual response from the generative AI model corresponding to the request of Step 10. Server parses the response according to expected patterns, for example by splitting items into exercises, questions, and feedback segments. Server validates the structure and discards or corrects segments that do not conform to predefined schemas. The input of Step 11 is the raw response text from the generative AI model. The output of Step 11 is structured learning-content information and feedback information derived from the response.

### Step 12

Server adjusts content difficulty and scheduling based on emotion state and progress.

Server takes the structured learning-content information and feedback information from Step 11 and modifies difficulty labels, content quantity, and presentation order based on the emotion state and ability-evaluation information from earlier steps. For example, server may filter out overly difficult items when the user is stressed, or insert review items when error rates are high. Server computes a scheduling plan that assigns each content unit a position in a sequence. The input of Step 12 is the structured learning-content information, feedback information, ability-evaluation information, and emotion state. The output of Step 12 is adjusted learning-content information and an ordered plan for presentation.

### Step 13

Server transmits adjusted learning content and feedback to the terminal.

Server encodes the adjusted learning-content information, the feedback information, and the presentation plan into a response message and sends this message to the terminal using a communication protocol. The input of Step 13 is the adjusted content and plan from Step 12. The output of Step 13 is a network message that delivers the next set of learning materials and feedback to the terminal.

### Step 14

Terminal renders learning content and feedback to the user.

Terminal receives the response message from the server, parses the content structures, and maps them to user interface components such as text views, buttons, audio players, and highlight markers. Terminal displays learning exercises, explanations, and encouragement messages on the screen and plays audio prompts when required. The input of Step 14 is the response message from Step 13. The output of Step 14 is a visible and audible presentation of learning-content information and feedback information to the user.

### Step 15

User consumes content and generates new learning interactions.

User reads the displayed text, listens to audio, answers questions, and practices speaking in response to prompts shown by the terminal. User may correct previously wrong answers based on feedback. The input of Step 15 is the rendered content and feedback from Step 14. The output of Step 15 is a new set of interactions, including correct and incorrect answers, revised attempts, and new utterances.

### Step 16

Terminal collects new interaction events and sensor data for the next cycle.

Terminal records each new answer, response time, and navigation action generated in Step 15 and again captures sensor data representing facial expressions and voice tone. Terminal transforms these into structured logs and feature vectors in the same format as in Step 2. The input of Step 16 is the new interactions and sensor readings derived from Step 15. The output of Step 16 is an updated batch of learning-related information and emotion-related information that is ready to be transmitted to the server for another iteration of the processing flow.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

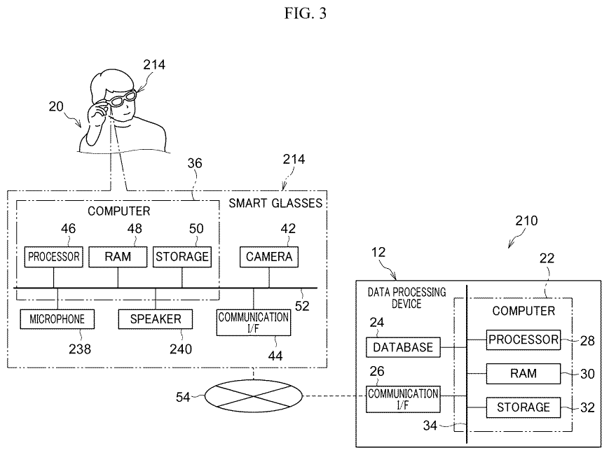

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

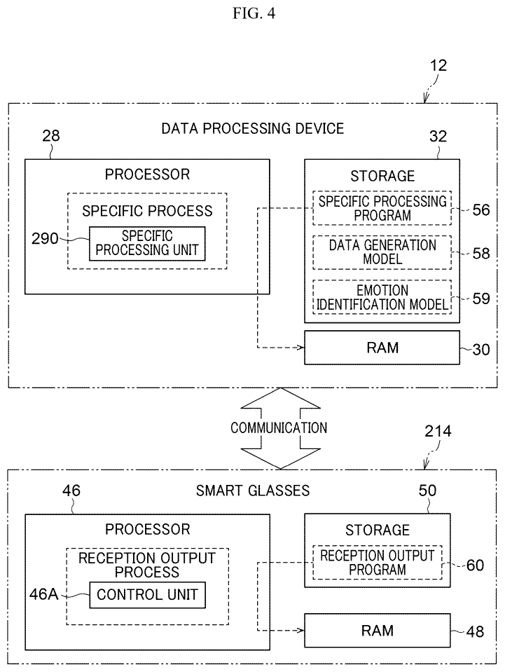

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

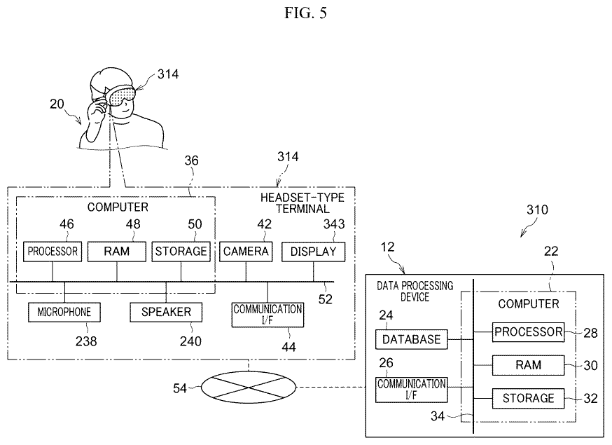

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

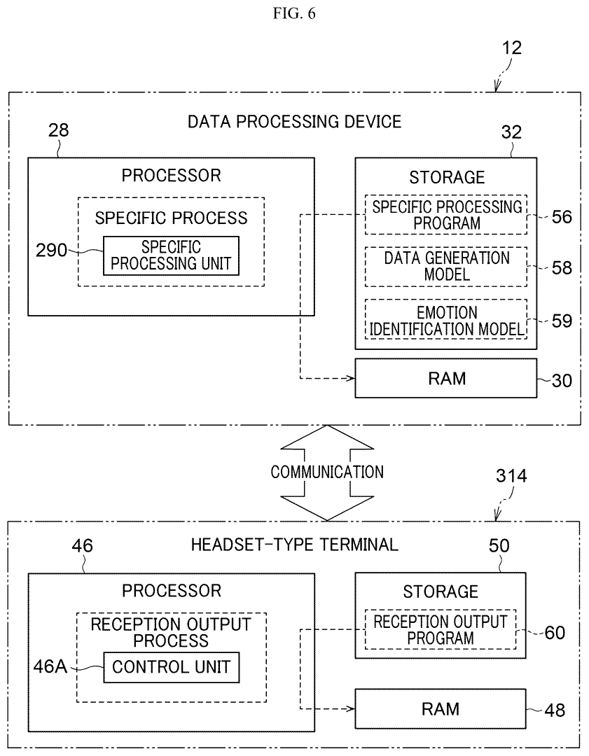

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

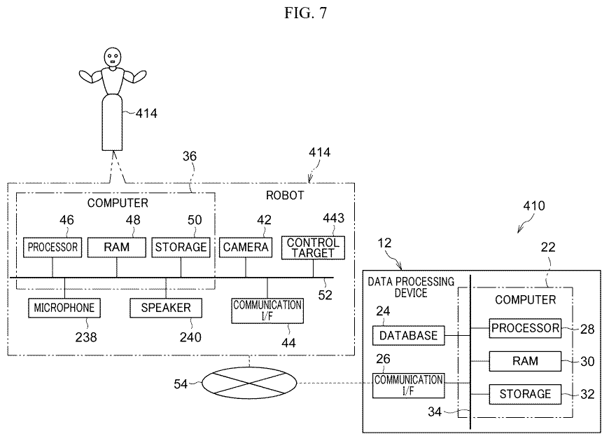

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

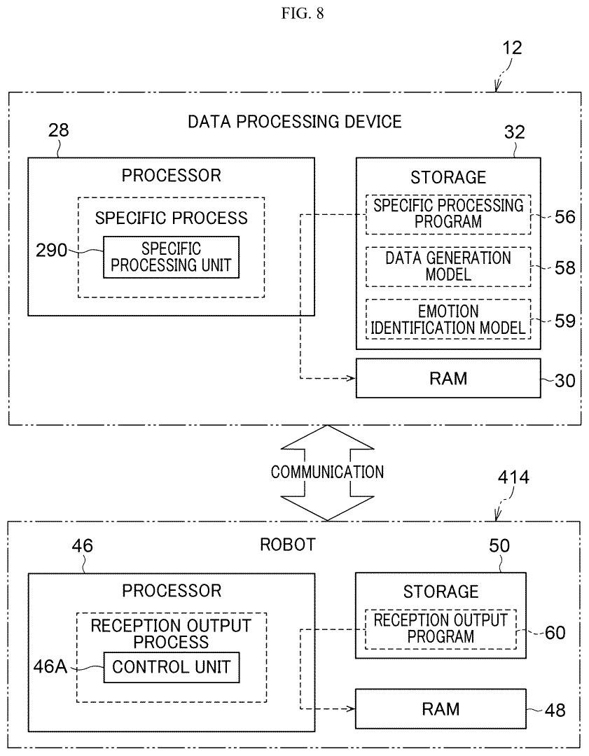

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

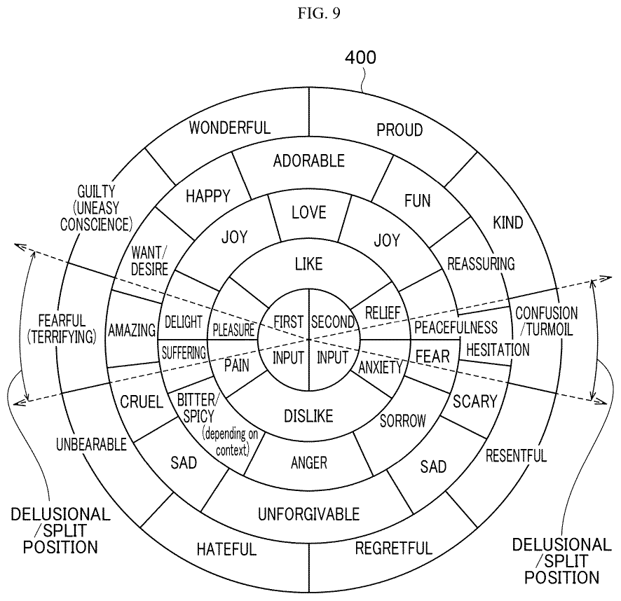

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

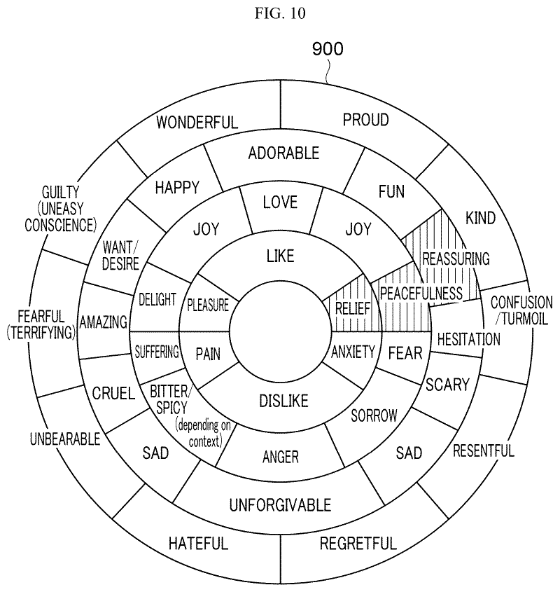

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive language data including English from a user via a user interface of a terminal, convert the language data into character string data using a speech recognition function when the language data is audio data,
obtain analysis target data as the language data when the language data is text data or as the character string data converted from the audio data, and input a prompt sentence to a generative artificial intelligence model so as to cause the generative artificial intelligence model to execute analysis processing for identifying grammatical errors and inappropriate lexical usage in the analysis target data,
execute an audio evaluation function on language data including audio in order to evaluate quality of pronunciation and accent and to identify pronunciation problems on a word unit basis or a phoneme unit basis,
classify errors relating to grammar, vocabulary, and pronunciation into categories on the basis of an analysis result obtained by the generative artificial intelligence model and an evaluation result obtained by the audio evaluation function, and store and update the classified categories as a weakness profile for each user in a storage device,
generate, on the basis of the weakness profile and the analysis target data, a prompt sentence to be input to the generative artificial intelligence model so as to cause the generative artificial intelligence model to generate feedback including explanations of user weaknesses, correction examples, and learning example sentences, and acquire feedback data output from the generative artificial intelligence model,
cause the feedback data to be displayed via the user interface and presented to the user, obtain, from the user via the user interface, an input including a prompt sentence requesting additional grammar checking or generation of practice problems, generate a new prompt sentence for the generative artificial intelligence model on the basis of the prompt sentence and the weakness profile, input the new prompt sentence to the generative artificial intelligence model, and provide additional feedback or practice problems corresponding to output obtained from the generative artificial intelligence model to the user.

### Supplementary 2

The system according to supplementary 1,
wherein the processor is configured to
input, to the generative artificial intelligence model, a prompt sentence that causes the generative artificial intelligence model to output, in a structured format, positions of grammatical errors and inappropriate lexical usage in the analysis target data and to output, for each error, a correction example and a concise explanation, and update the weakness profile by calculating occurrence frequency for each error category on the basis of the structured output.

### Supplementary 3

The system according to supplementary 1,
wherein the processor is configured to
dynamically change contents of the prompt sentence to be input to the generative artificial intelligence model on the basis of past analysis results of the user and the weakness profile, and control a level of detail of feedback, a difficulty of explanations, and types of practice problems to be presented to the user.

### Application Example 1

### Supplementary 1

A system comprising a processor,
wherein the processor is configured to
acquire, via an input/output device, language information from a user, the language information including at least one of character information and sound information,
convert, when the sound information is acquired, the sound information into character information by using a sound processing device, and store a conversion result as the language information of the user in a storage device,
supply the language information of the user to a generative AI model while generating and providing to the generative AI model a prompt sentence as auxiliary information for inputting the language information into the generative AI model, and cause the generative AI model to analyze language ability of the user,
analyze an output result obtained from the generative AI model in accordance with a structured output format, calculate, for each of a sentence structure field, a listening field, a speaking field, and a vocabulary field, at least one of a type and a frequency of an error, and generate a weakness index corresponding to each of the fields,
estimate a proficiency level of the user based on the weakness index and past learning history information of the user, and select a target learning resource from among a plurality of learning resources stored in a resource storage device in accordance with the proficiency level and the weakness index of each field,
cause the generative AI model to generate feedback information by inputting, to the generative AI model, a prompt sentence for generating the feedback information, the feedback information including at least one of a corrected expression, an explanatory expression, a practice task, and a dialog text for conversation practice related to a weakness of the user, based on contents of the selected learning resource, the output result obtained from the generative AI model, and the weakness index, and obtaining the feedback information from the generative AI model,
and present, via the input/output device, the feedback information and the selected learning resource to the user, and, in response to new language information from the user, repeatedly perform the analysis, updating of the weakness index, and selection of the learning resource.

### Supplementary 2

The system according to supplementary 1,
wherein the processor is configured to
use, as the prompt sentence to be input to the generative AI model, a prompt sentence that instructs the generative AI model to identify at least one of an error in sentence structure and a problem in phoneme in the language information of the user, and to output, in at least one of a list format and a machine-readable format, a correct expression for each error and a reason for the correct expression,
generate the weakness index based on the output,
search the resource storage device for a learning resource corresponding to a type of the error, and select and present a learning resource having a difficulty level corresponding to the proficiency level.

### Supplementary 3

The system according to supplementary 1,
wherein the processor is configured to
store, in the storage device for each user, the weakness index and the proficiency level in time series,
include the stored time-series information in the prompt sentence to be input to the generative AI model so as to cause the generative AI model to perform evaluation and feedback generation in consideration of past learning states,
and dynamically change at least one of a type and a difficulty level of the learning resource in accordance with a change amount of the time-series information.

### Example 2

### Supplementary 1

A system comprising a processor,
wherein the processor is configured to
acquire learning data from a user via a terminal device and store the learning data as accumulated information in a storage area,
obtain the learning data from the storage area, statistically analyze the learning data by using a data processing program and a tabular data structure, and generate an analysis result indicating candidate weaknesses of the user,
generate feature data based on the analysis result and a learning history of the user, and process the feature data as input to a machine learning model to calculate an estimation result indicating effectiveness values for a plurality of learning material candidates,
select recommended learning materials from the learning material candidates based on the estimation result, and generate a prompt sentence including information on the candidate weaknesses and information on the recommended learning materials,
input the prompt sentence into a generative AI model, and obtain output data from the generative AI model, the output data including feedback information corresponding to the weaknesses of the user and the recommended learning materials, and
convert the output data and the information on the recommended learning materials into user interface data, transmit the user interface data to the terminal device via a communication device, and cause the terminal device to display the user interface data.

### Supplementary 2

The system according to supplementary 1,
wherein the processor is configured to
hold the learning data as the tabular data structure by using a data processing library when statistically analyzing the learning data, calculate indicators including an error rate, a score distribution, and a learning trend, identify weaknesses of the user based on predetermined threshold conditions, and generate structured data representing the identified weaknesses for input to the machine learning model and the generative AI model.

### Supplementary 3

The system according to supplementary 1,
wherein the processor is configured to
dynamically change content of the prompt sentence based on the learning history of the user and the estimation result by the machine learning model, and generate the prompt sentence including instruction information that specifies a detail level of the feedback information, a presentation format of the feedback information, and a method of presenting a learning order to be provided by the generative AI model, thereby adjusting the feedback information according to a learning progress of the user.

### Application Example 2

### Supplementary 1

A system comprising a processor,
wherein the processor is configured to
receive learning-related information of a user from a user interface and a storage device, the learning-related information including at least language data of the user and operation history of the user in a learning activity, and receive emotion-related information of the user obtained from at least one sensing device or from an input of the user,
generate ability-evaluation information and weakness-region information of the user by causing computational resources in an information processing apparatus to execute an analysis process based on the learning-related information and the emotion-related information,
generate a prompt sentence for a generative AI model based on the ability-evaluation information and the weakness-region information, the prompt sentence instructing the generative AI model to analyze the weakness region of the user and to select or generate learning content to be provided to the user,
input the prompt sentence and at least part of the learning-related information to the generative AI model and cause the generative AI model to execute an analysis process and a content-generation process,
identify a weakness region of the language ability of the user based on an analysis result obtained from the generative AI model and extract or generate learning-content information and feedback information corresponding to the weakness region,
dynamically adjust at least one of a difficulty level, an amount, and a presentation order of the learning-content information based on the emotion-related information,
present the adjusted learning-content information and the feedback information to the user via the user interface, continuously acquire learning operation history of the user as additional learning-related information, store the additional learning-related information in the storage device, and repeatedly update contents of the prompt sentence input to the generative AI model and the learning-content information based on the additional learning-related information.

### Supplementary 2

The system according to supplementary 1,
wherein the processor is configured to generate the prompt sentence for the generative AI model so as to include instructions, based on document data or speech-recognition data included in the learning-related information, to identify grammatical errors, to evaluate vocabulary use, to evaluate pronunciation, and to generate explanations corresponding to a comprehension level of the user, and to cause, based on a response obtained from the generative AI model, correction examples, additional example sentences, and
learning-guidance information to be presented to the user on the user interface.

### Supplementary 3

The system according to supplementary 1,
wherein the processor is configured to use learning-progress information including at least one of learning history information, performance-transition information, response-time information, and emotion-state-estimation information of the user to change contents of the prompt sentence to be input to the generative AI model, to dynamically determine, based on output obtained from the generative AI model, at least one of a type, a difficulty level, and a presentation order of next learning content to be provided, and to automatically update feedback information and review-content information in accordance with a learning progress and an emotion state of the user.

What is claimed is:

1. A system comprising:
circuitry configured to:
receive, via a communication interface coupled to a packet-switched network, input data comprising at least one of text data or audio data from a terminal device operated by a user;
construct a first prompt data structure based on the input data and transmit the first prompt data structure to a generative neural network model to instruct the generative neural network model to analyze a characteristic of the input data using natural language processing, and obtain analysis result data from the generative neural network model;
evaluate the analysis result data to identify one or more deficiency indicators associated with the input data;
construct a second prompt data structure based on the identified one or more deficiency indicators and transmit the second prompt data structure to the generative neural network model to cause the generative neural network model to generate remediation output data corresponding to the one or more deficiency indicators; and
transmit, via the communication interface, the remediation output data to the terminal device for presentation via a user interface of the terminal device.

2. The system according to claim 1, wherein the circuitry is configured to convert the audio data into character-string data using a speech recognition resource prior to constructing the first prompt data structure.

3. The system according to claim 2, wherein the circuitry is configured to execute an audio evaluation function on the audio data to evaluate pronunciation quality and accent characteristics on at least one of a word-unit basis or a phoneme-unit basis, and to incorporate evaluation results into the analysis result data.

4. The system according to claim 3, wherein the circuitry is configured to classify the one or more deficiency indicators into categories based on the analysis result data and the audio evaluation results, and to store and update the classified categories as a proficiency profile for the user in a storage device.

5. The system according to claim 4, wherein the second prompt data structure is constructed based on the proficiency profile and the input data, such that the remediation output data is adapted to address deficiency indicators having highest frequency in the proficiency profile.

6. The system according to claim 1, wherein the first prompt data structure includes instructions that cause the generative neural network model to output the analysis result data in a structured format comprising positions of identified errors, correction examples for each error, and concise explanations.

7. The system according to claim 6, wherein the circuitry is configured to parse the structured format of the analysis result data and to calculate occurrence frequency for each deficiency category, and to update a proficiency profile stored in a storage device based on the calculated frequencies.

8. The system according to claim 1, wherein the remediation output data comprises at least one of explanations of identified deficiencies, correction examples, or practice problem data generated by the generative neural network model.

9. The system according to claim 8, wherein the circuitry is configured to receive, from the terminal device via the communication interface, a follow-up request from the user, to construct a third prompt data structure based on the follow-up request and a proficiency profile stored in a storage device, and to transmit the third prompt data structure to the generative neural network model to obtain additional remediation output data.

10. The system according to claim 1, wherein the generative neural network model comprises a transformer architecture with self-attention layers, and wherein the circuitry is configured to control inference parameters comprising at least one of a temperature parameter, a top-k sampling threshold, or a maximum output length during generation of the analysis result data and the remediation output data.

11. The system according to claim 1, wherein the circuitry is configured to adjust a granularity and a difficulty level of the remediation output data based on historical interaction data of the user stored in a storage device, such that the remediation output data is dynamically modified in consideration of a progression of the user over time.

12. The system according to claim 1, wherein the characteristic of the input data analyzed by the generative neural network model comprises at least one of grammatical structure, lexical appropriateness, or syntactic complexity of text represented by the input data.

13. The system according to claim 12, wherein the one or more deficiency indicators comprise at least one of grammatical error indicators, inappropriate word usage indicators, or sentence structure deficiency indicators identified from the analysis result data.

14. The system according to claim 1, wherein the circuitry is configured to estimate an emotional state of the user based on at least one of expression data, audio signal data, or interaction pattern data received from the terminal device, and to adjust a tone or a presentation style of the remediation output data in accordance with the estimated emotional state.

15. The system according to claim 14, wherein the circuitry is configured to estimate the emotional state using an emotion recognition resource comprising a neural network classifier that outputs a probability distribution over a plurality of discrete emotional state categories.

16. The system according to claim 1, wherein the circuitry is configured to generate, based on the one or more deficiency indicators, interactive practice content data comprising fill-in-the-blank exercises, sentence rewriting tasks, or conversation simulation prompts, and to transmit the interactive practice content data to the terminal device.

17. The system according to claim 1, wherein the circuitry is configured to store the input data, the analysis result data, the deficiency indicators, and the remediation output data in association with a user identifier in a storage device, and to use the stored data to update at least one of the first prompt data structure or the second prompt data structure for a subsequent interaction with the user.

18. A system comprising:
circuitry configured to:
receive, via a communication interface coupled to a packet-switched network, input data comprising at least one of text data or audio data from a terminal device;
convert audio data, when present in the input data, into character-string data using a speech recognition resource, and execute an audio evaluation function on the audio data to generate pronunciation evaluation data;
construct a first prompt data structure and transmit the first prompt data structure to a generative neural network model comprising a transformer architecture with self-attention layers, instructing the generative neural network model to analyze the input data and output analysis result data in a structured format comprising error positions, correction examples, and explanations;
classify deficiency indicators from the analysis result data and the pronunciation evaluation data into categories, and store the categories as a proficiency profile in a storage device;
construct a second prompt data structure based on the proficiency profile and the input data, and cause the generative neural network model to generate remediation output data comprising explanations, corrections, and practice content adapted to the proficiency profile; and
transmit the remediation output data to the terminal device for presentation via a user interface of the terminal device.

19. The system according to claim 18, wherein the circuitry is configured to estimate an emotional state of the user based on at least one of expression data, audio signal data, or interaction pattern data, and to adjust a tone or a granularity of the remediation output data in accordance with the estimated emotional state.

20. A method comprising:
receiving, via a communication interface coupled to a packet-switched network, input data comprising at least one of text data or audio data from a terminal device operated by a user;
constructing a first prompt data structure based on the input data and transmitting the first prompt data structure to a generative neural network model to instruct the generative neural network model to analyze a characteristic of the input data using natural language processing, and obtaining analysis result data from the generative neural network model;
evaluating the analysis result data to identify one or more deficiency indicators associated with the input data;
constructing a second prompt data structure based on the identified one or more deficiency indicators and transmitting the second prompt data structure to the generative neural network model to cause the generative neural network model to generate remediation output data corresponding to the one or more deficiency indicators; and
transmitting, via the communication interface, the remediation output data to the terminal device for presentation via a user interface of the terminal device.
